(19) United States
(12) Patent Application Publication
(10) Pub. No.: US 2015/0199175 A1
(43) Pub. Date: Jul. 16, 2015

(54) Systems and Methods for Performing Randomness and Pseudorandomness Generation, Testing, and Related Cryptographic Techniques

(71) Applicant: Yongge Wang, Matthews, NC (US)

(72) Inventor: Yongge Wang, Matthews, NC (US)

(21) Appl. No.: 14/152,313

(22) Filed: Jan. 10, 2014

(51) Int. Cl. G06F 7/58

(52) U.S. Cl. CPC G06F 7/588; G06F 7/582

(57) ABSTRACT

Random numbers have been one of the most useful objects in statistics, computer science, cryptography, modeling, simulation, and other applications though it is very difficult to construct true randomness. In 2010, National Institute of Science and Technologies (NIST) publishes the SP800-22 Revision 1A test suite. However, this suite has inherent limitations with straightforward Type II errors.

This invention concerns statistical distance based testing techniques for evaluating the quality of pseudorandom and random sources that are used in many applications such as cryptographic systems. This invention also concerns statistical testing techniques based on the common statistical laws such as the law of the iterated logarithms. The statistical distance based approach in this invention is more accurate in deviation detection and avoids afore mentioned type II errors in NIST SP800-22.

### CROSS-REFERENCES TO RELATED APPLICATIONS

This application is entitled to the benefit of Provisional Patent Application Ser. No. 61/764,753 filed on Feb. 14, 2013.

### U.S. Patent Documents

Coron Jean-Sebastien, Naccache David. Method for improving random testing. U.S. Pat. No. 6,990,201. (1999)
Vasyltsov, I. and Kim, Y. S. and Eduard, H. Apparatus and methods for autonomous testing of random number generators. U.S. Pat. No. 8,250,128. (2012)
Matthew A. Blaze. System and method for constructing a cryptographic pseudo random bit generator. U.S. Pat. No. 5,909,494. (1997)

### Foreign Patent Documents

Coron Jean-Sebastien, Naccache David. Method for improving random testing. WO2000010284, 1999. Also published as CN1323477A, EP1105997A1, and U.S. Pat. No. 6,990,201.
Matthew A. Blaze. System and method for constructing a cryptographic pseudo random bit generator. WO1998036525, (1997).

### Other Publications

E. Barker and J. Kelsey. NIST SP 800-90A: Recommendation for Random Number Generation Using Deterministic Random Bit Generators. NIST, 2012.
J. A. Clarkson and C. R. Adams. On definitions of bounded variation for functions of two variables. Tran. AMS, 35(4):824-854, 1933.
P. Erdös and M. Kac. On certain limit theorems of the theory of probability. Bulletin of AMS, 52(4):292-302, 1946.
W. Feller. The fundamental limit theorems in probability. Bulletin of AMS, 51(11):800-832, 1945.
W. Feller. Introduction to probability theory and its applications, volume I. John Wiley & Sons, Inc., New York, 1968.
S. Goldwasser and S. Micali. Probabilistic encryption. J. Comput. Sys. Sci., 28(2):270-299, 1984.
E. Hellinger. Neue begriindung der theorie quadratischer formen von unendlichvielen veränderlichen. J. für die reine und angewandte Mathematik, 136:210-271, 1909.
P. Martin-Löf. The definition of random sequences. Inform. and Control, 9:602-619, 1966.
A. Khintchine. Über einen satz der wahrscheinlichkeitsrechnung. Fund. Math, 6:9-20, 1924.
A. Rukhin, J. Soto, J. Nechvatal, M. Smid, E. Barker, S. Leigh, M. Levenson, M. Vangel, D. Banks, A. Heckert, J. Dray, and S. Vo. A Statistical Test Suite for Random and Pseudorandom Number Generators for Cryptographic Applications. NIST SP 800-22, 2010.
C. P. Schnorr. Zufälligkeit und Wahrscheinlichkeit. Lecture Notes in Math. 218. Springer Verlag, 1971.
J. Ville. Etude Critique de la Notion de Collectif. Gauthiers-Villars, Paris, 1939
R. von Mises. Grundlagen der wahrscheinlichkeitsrechung. Math. Z., 5:52-89, 1919.
Yongge Wang. Resource bounded randomness and computational complexity. Theoret. Comput. Sci., 237:33-55, 2000.
Yongge Wang. A comparison of two approaches to pseudorandomness. Theoretical computer science, 276(1):449-459, 2002.
A. C. Yao. Theory and applications of trapdoor functions. In Proc. 23rd IEEE FOCS, pages 80-91, 1982.

### BACKGROUND

1. Field of the Invention

The present invention relates to statistical testing techniques for evaluating the quality of random and pseudorandom sources.

The present invention further relates to secure pseudorandom sequence generation in cryptographic systems. The basic types of things that the invention improves include two kinds of techniques. The first technique is a method and system to evaluate statistical properties of random sequences in cryptographic applications. The second technique is a method and system to design pseudorandom generators that will produce high quality pseudorandom sequences satisfying common statistical laws such as the law of iterated logarithm.

2. Discussion of Prior Art

Random numbers have been one of the most useful objects in statistics, computer science, cryptography, modeling, simulation, and other applications though it is very difficult to construct true randomness. Secure cryptographic hash functions such as SHA1, SHA2, and SHA3 and symmetric key block ciphers (e.g., AES and TDES) have been commonly used to design pseudorandom generators with counter modes (e.g., in Java Crypto Library and in NIST SP800-90A standards).

Though security of hash functions such as SHA1, SHA2, and SHA3 has been extensively studied from the one-wayness and collision resistant aspects, there has been limited research on the quality of long pseudorandom sequences generated by cryptographic hash functions. Even if a hash function (e.g., SHA1) performs like a random function based on existing statistical tests specified by NIST SP800-22 Revision 1A in Rukhin, et al. (2010), when it is called many times for a long sequence generation, the resulting long sequence may not satisfy the properties of pseudorandomness and could be distinguished from a uniformly chosen sequence.

Statistical tests are commonly used as a first step in determining whether or not a generator produces high quality random bits. For example, NIST SP800-22 Revision 1A in Rukhin, et al. (2010) proposed the state of art statistical testing techniques for determining whether a random or pseudorandom generator is suitable for a particular cryptographic application. NIST SP800-22 includes 15 tests: frequency (monobit), number of 1-runs and 0-runs, longest-1-runs, binary matrix rank, discrete Fourier transform, template matching, Maurer's “universal statistical” test, linear complexity, serial test, the approximate entropy, the cumulative sums (cusums), the random excursions, and the random excursions variants. In a statistical test of NIST SP800-22 Revision 1A in Rukhin, et al. (2010), a significance level α ∈ [0.001, 0.01] is chosen for each test. For each input sequence, a P-value is calculated and the input string is accepted as pseudorandom if P-value≧α. A pseudo-random generator is considered good if, with probability α, the sequences produced by the generator fail the test. For an in-depth analysis, NIST SP800-22 recommends additional statistical procedures such as the examination of P-value distributions (e.g., using χ²-test).

NIST SP800-22 Revision 1A test suite in Rukhin, et al. (2010) has inherent limitations with straightforward Type II errors. For example, for a function F that mainly outputs “random strings” but, with probability α, outputs biased strings (e.g., strings consisting mainly of 0's), F will be considered as a “good” pseudorandom generator by NIST SP800-22 test though the output of F could be distinguished from the uniform distribution (thus, F is not a pseudorandom generator by definition).

In the following, we use two examples to illustrate this kind of Type II errors. Let RAND_{c,n} be the sets of Kolmogorov c-random binary strings of length n, where c≧1. That is, for a universal Turing machine M, let

RAND_{c,n}={x ∈ {0, 1}ⁿ: if M(y)=x then |y|≧|x|−c}.

Let α be a given significance level of NIST SP800-22 test and R₂ₙ=R₁ ∪ R₂ where R₁ is a size 2ⁿ(1−α) subset of RAND_{2,2n} and R₂ is a size 2ⁿα subset of {0ⁿx:x ∈ {0, 1}ⁿ}. Furthermore, let fₙ:{0,1}ⁿ→R₂ₙ be an ensemble of random functions (not necessarily computable) such that f(x) is chosen uniformly at random from R₂ₙ. Then for each n-bit string x, with probability 1−α, fₙ(x) is Kolmogorov 2-random and with probability α, fₙ(x) ∈ R₂. Since all Kolmogorov 2-random strings are guaranteed to pass NIST SP800-22 test at significance level a (otherwise, they are not Kolmogorov 2-random by definition) and all strings in R₂ fail NIST SP800-22 test at significance level a for large enough n, the function ensemble {fₙ}_{n∈N} is considered as a “good” pseudorandom generator by NIST SP800-22 test suite. On the other hand, Theorem 3.2 in Wang (2002) shows that RAND_{2,2n} (and R₁) could be efficiently distinguished from the uniform distribution with a non-negligible probability. A similar argument could be used to show that R₂ₙ could be efficiently distinguished from the uniform distribution with a non-negligible probability. In other words, {fₙ}_{n∈N} is not a cryptographically secure pseudorandom generator.

As another example, let {f′ₙ}_{n∈N} be a pseudorandom generator with f′ₙ: {0, 1}ⁿ→{0, 1}^{l(n)} where l(n)>n. Assume that {f′ₙ}_{n∈N} is a good pseudorandom generator by NIST SP800-22 in-depth statistical analysis of the P-value distributions (e.g., using χ²-test). Define a new pseudorandom generators {fₙ}_{n∈N} as follows:

$${f}_{n} ( x ) = \{ \begin{matrix}{f}_{n}^{′} ( x ) & if {f}_{n}^{′} ( x ) contains more 0 ’ s than 1 ’ s \\ {f}_{n}^{′} ( x ) ⊗ {1}^{l ( n )} & otherwise\end{matrix}$$

Then it is easy to show that {fₙ}_{n∈N} is also a good pseudorandom generator by NIST SP800-22 in-depth statistical analysis of the P-value distributions (e.g., using χ²-test). However, the output of {fₙ}_{n∈N} is trivially distinguishable from the uniform distribution.

The afore mentioned two examples show the limitation of testing approaches specified in NIST SP800-22. The limitation is mainly due to the fact that NIST SP800-22 does not fully realize the differences between the two common approaches to pseudo-randomness definitions as observed and analyzed in Wang (2002). In other words, the definition of pseudorandom generators is based on the “behavioristic” approach of indistinguishability concepts though techniques in NIST SP800-22 mainly concentrate on the performance of individual strings.

Feller (1945) mentioned that the two fundamental limit theorems of random binary strings are the central limit theorem and the law of the iterated logarithm. Feller (1945) also called attention to the study of the behavior of the maximum of the absolute values of the partial sums

$${\overline{S}}_{n} = \frac{{max}_{1 \leq k \leq n} \vert 2 S ( ξ ↾ k ) \vert - n}{\sqrt{n}}$$

and Erdos and Kac (1946) obtained the limit distribution of S̅ₙ. NIST SP800-22 test suite includes several frequency related tests that cover the first central limit theorem and includes the cusum test that covers the limit distribution of S̅ₙ. However it does not include any test for the important law of the iterated logarithm. The law of the iterated logarithm (LIL) says that, for a pseudorandom sequence ξ, the value Sₗᵢₗ(ο[0 . . . n−1]) should stay in [−1, 1] and reach both ends infinitely often when n increases.

Several inventors have created several types of techniques to evaluate the quality of random and pseudorandom sources. U.S. Pat. No. 6,990,201 to Coron and Naccache (1999) discloses a method for testing sources generating random numbers, particularly sources set up in the context of cryptographic systems such as random number generators incorporated in chip cards. This patent is a kind of universal tests that are discussed in NIST SP800-22 and is limited in testing the performance of a single sequence instead of a collection of sequences. U.S. Pat. No. 8,250,128 to Vasyltsov, Kim, and Eduard (2007) discloses a test unit that performs a test on the random numbers to determine whether the transmitted random numbers are within a statistical range. This patent is also a kind of statistical tests that are similar to the NIST SP800-22 test suite and is limited in testing the performance of a single sequence instead of a collection of sequences. U.S. Pat. No. 5,909,494 to Blaze (1997) discloses a pseudo-random bit generator using Feistel constructions and it does not address the comprehensive testing techniques on pseudorandom generators.

As a summary, the existing techniques and patents for randomness testing are mainly based on the performance of individual strings instead of taking a “behavioristic” approach.

### SUMMARY

This invention concerns statistical distance based testing techniques for evaluating the quality of pseudorandom and random sources that are used in many applications such as cryptographic systems. This invention also concerns statistical testing techniques based on the common statistical laws such as the law of the iterated logarithms.

Instead of focusing on the performance of individual strings, this invention discloses testing techniques that are based on statistical distances such as root-mean-square deviation or Hellinger distance. The statistical distance based approach is more accurate in deviation detection and avoids afore mentioned type II errors in NIST SP800-22 and exiting techniques.

### BRIEF DESCRIPTION OF THE DRAWINGS

For a more complete understanding of the invention, reference is made to the following description and accompanying drawings, in which:

FIG. 1 is a schematic diagram illustrating a process according to an embodiment of the invention, showing steps taken for evaluating a pseudorandom generator quality with a statistical distance based testing;

FIG. 2 is a schematic diagram illustrating a process according to an embodiment of the invention, showing steps taken for evaluating the quality of a collection of sequences using the weak and strong LIL tests;

FIG. 3 is a schematic diagram illustrating a process according to an embodiment of the invention, showing steps taken for evaluating the quality of a collection of sequences using the law of iterated logarithms;

FIG. 4 is a schematic diagram illustrating three processes according to an embodiment of the invention, showing steps taken for calculating the total variation distance, Hellinger distance, root-mean-square deviation, and average absolute probability;

FIG. 5 is a schematic diagram illustrating the process of improving the design a pseudorandom generator using the snapshot LIL test, weak LIL test, and strong LIL test;

FIG. 6 is a schematic representation of normal distribution curves for the ideal snapshot LIL tests according to an embodiment of the invention;

FIG. 7 is a schematic representation of a statistical distance based test illustrating the distance between the actual output of a pseudorandom generator and the ideal output of a perfect pseudorandom generator;

FIG. 8 is a schematic table illustrating the probabilities that an ideal random sequence passes the weak LIL tests according to an embodiment of the invention; and

FIG. 9 is a schematic table illustrating the probabilities that an ideal random sequence passes the snapshot LIL tests according to an embodiment of the invention.

### DESCRIPTION OF INVENTION

In this invention, N and R⁺ denotes the set of natural numbers (starting from 0) and the set of non-negative real numbers, respectively. Σ={0, 1} is the binary alphabet, Σ* is the set of (finite) binary strings, Σⁿ is the set of binary strings of length n, and Σ^{∞} is the set of infinite binary sequences. The length of a string x is denoted by |x|. λ is the empty string. For strings x, y ∈ Σ*, xy is the concatenation of x and y, x [symbol] y denotes that x is an initial segment of y. For a sequence x ∈ Σ* ∪ Σ^{∞} and a natural number n≧0, x [symbol] n=x[0 . . . n−1] denotes the initial segment of length n of x (x [symbol] n=x[0 . . . n−1]=x if |x|≦n) while x[n] denotes the nth bit of x, i.e., x[0 . . . n−1]=x[0] . . . x[n−1]. For a set C of infinite sequences, Prob[C] denotes the probability that ξ ∈ C when ξ is chosen by a uniform random experiment. Martingales are used to describe betting strategies in probability theory.

Ville (1939) defines a martingale as a function F:Σ*→R⁺ such that, for all x ∈ Σ*,

$$F ( x ) = \frac{F ( x 1 ) + F ( x 0 )}{2} .$$

We say that a martingale F succeeds on a sequence ξ ∈ Σ^{∞} if lim supₙ F(ξ[0 . . . n−1])=∞.

The concept of “effective similarity” by Goldwasser and Micali (1984) and Yao (1982) is defined as follows. Let {Xₙ}_{n∈N} and {Yₙ}_{n∈N} be two probability ensembles. {Xₙ}_{n∈N} and {Yₙ}_{n∈N} are computationally (respectively, statistically) indistinguishable if for any polynomial time computable set D ∈ Σ* (respectively, any set D ∈ Σ*) and any polynomial p, the following inequality holds for almost all n.

$$\vert Prob [ A ( {X}_{n} ) = 1 ] - Prob [ A ( {Y}_{n} ) = 1 ] \vert \leq \frac{1}{p ( n )}$$

The pseudorandom generator concept is defined as follows: Let l: N→N with l(n)>n for all n∈ N, and {Uₙ}_{n∈N} be the uniform distribution. A pseudorandom generator is a polynomial-time algorithm G with the following properties:

1. |G(x)|=l(|x|) for all x ∈ Σ*.

2. The ensembles {G(Uₙ)}_{n∈N} and {Uₗ₍ₙ₎}_{n∈N} are computationally indistinguishable.

### Stochastic Properties of Long Pseudorandom Sequences

Classical infinite random sequences were first introduced as a type of disordered sequences, called “Kollektivs”, by von Mises (1919) as a foundation for probability theory. The two features characterizing a Kollektiv are: the existence of limiting relative frequencies within the sequence and the invariance of these limits under the operation of an “admissible place selection”. Here an admissible place selection is a procedure for selecting a subsequence of a given sequence ξ in such a way that the decision to select a term ξ[n] does not depend on the value of ξ[n]. Ville (1939) showed that von Mises' approach is not satisfactory by proving that: for each countable set of “admissible place selection” rules, there exists a “Kollektiv” which does not satisfy the law of the iterated logarithm (LIL). Later, Martin-Löf (1966) developed the notion of random sequences based on the notion of typicalness. A sequence is typical if it is not in any constructive null sets. Schnorr (1971) introduced p-randomness concepts by defining the constructive null sets as polynomial time computable measure 0 sets.

Polynomial time random sequences are defined as follows. An infinite sequence ξ ∈ Σ^{∞} is p-random (polynomial time random) if for any polynomial time computable martingale F, F does not succeed on ξ.

Since there is no efficient mechanism to generate p-random sequences, pseudo-random generators are commonly used to produce long sequences for cryptographic applications. While the required uniformity property for pseudorandom sequences is equivalent to the law of large numbers, the scalability property is equivalent to the invariance property under the operation of “admissible place selection” rules. Since p-random sequences satisfy common statistical laws, it is reasonable to expect that pseudorandom sequences produced by pseudorandom generators satisfy these laws also.

The law of the iterated logarithm (LIL) describes the fluctuation scales of a random walk. For a nonempty string x ∈ Σ*, let

$$S ( x ) = {\sum }_{i = 0}^{\vert x \vert - 1} x [ i ] and {S}^{*} ( x ) = \frac{2 \cdot S ( x ) - \vert x \vert}{\sqrt{\vert x \vert}}$$

where S(x) denotes the number of 1s in x and S*(x) denotes the reduced number of 1s in x. S*(x) amounts to measuring the deviations of S(x) from

$$\frac{\vert x \vert}{2}$$

in units of

$$\frac{1}{2} \sqrt{\vert x \vert} .$$

The law of large numbers says that, for a pseudo random sequence ξ, the limit of

$$\frac{S ( ξ ↾ n )}{n} is \frac{1}{2} ,$$

which corresponds to the frequency (Monobit) test in NIST SP800-22. But it says nothing about the reduced deviation S*(ξ [symbol] n). It is intuitively clear that, for a pseudorandom sequence ξ, S*(ξ [symbol] n) will sooner or later take on arbitrary large values (though slowly). The law of the iterated logarithm (LIL), which was first discovered by Khintchine (1924), gives an optimal upper bound \sqrt{2ln ln n} for the fluctuations of S*(ξ [symbol] n). It was showed in Wang (2000) that this law holds for p-random sequences also.

The LIL for p-random sequences by Wang (2000) is described as follows.

Theorem 1 (LIL for p-random sequences by Wang (2000)) For a sequence ξ ∈ Σ^{∞}, let

$${S}_{lil} ( ξ ↾ n ) = \frac{2 {\sum }_{i = 0}^{n - 1} ξ [ i ] - n}{\sqrt{2 n ln ln n}} . \qquad ( 1 )$$

Then for each p-random sequence ξ ∈ Σ^{∞}, we have both lim sup_{n→∞}Sₗᵢₗ(ξ [symbol] n)=1 and lim inf_{n→∞}Sₗᵢₗ(ξ [symbol] n)=−1.

### Normal Approximations to Sₗᵢₗ

The normal density function with mean μ and variance σ is defined as

$$f ( x ) = \frac{1}{σ \sqrt{2 π}} {e}^{- \frac{{( x - μ )}^{2}}{2 {σ}^{2}}} ;$$

For μ=0 and σ=1, we have the standard normal density function φ(x) and the standard normal distribution function Φ(x).

$$ϕ ( x ) = \frac{1}{\sqrt{2 π}} {e}^{- \frac{{x}^{2}}{2}} , Φ ( x ) = {\int }_{- ∞}^{x} ϕ ( y ) d y$$

From the approximation Theorem on page 181 of Feller (1968), we can derive the following DeMoivre-Laplace limit approximation theorem.

Theorem 2 For fixed x₁, x₂, we have

$${lim}_{n -> ∞} Prob [ {x}_{1} \leq {S}^{*} ( ξ ↾ n ) \leq {x}_{2} ] = Φ ( {x}_{2} ) - Φ ( {x}_{1} ) . \qquad ( 2 )$$

The growth speed for the above approximation is bounded by max{k²/n², k⁴/n³} where

$$k = S ( ξ ↾ n ) - \frac{n}{2} .$$

The following lemma is useful for interpreting S* based approximation results into Sₗᵢₗ based approximation. It is obtained by noting the fact that \sqrt{2 ln ln n}·Sₗᵢₗ(ξ [symbol] n)=S*(ξ [symbol] n).

Lemma 3 For any x₁, x₂, we have

Prob[x₁<Sₗᵢₗ(ξ→n)<x₂]=Prob[x₁\sqrt{2 ln ln n}<S*(ξ [symbol] n)<x₂ \sqrt{2 ln ln n}].

In this invention, we only consider statistical tests for n≧2²⁶ and x₂≦1. That is, S*(ξ [symbol] n)≦\sqrt{2 ln ln n}. Thus we have

$$k = S ( ξ ↾ n ) - \frac{n}{2} ≃ \frac{\sqrt{n}}{2} {S}^{*} ( ξ ↾ n ) \leq \sqrt{2 n ln ln n} / 2.$$

Hence, we have

$$max \{ \frac{{k}^{2}}{{n}^{2}} , \frac{{k}^{4}}{{n}^{3}} \} = \frac{{k}^{2}}{{n}^{2}} = \frac{{( 1 - α )}^{2} ln ln n}{2 n} < {2}^{- 22}$$

In other words, the probability approximation errors in this invention will be bounded by 0.0000002<2²².

### Weak-LIL Test and Design

In the previous paragraphs, we mentioned that pseudorandom sequences should satisfy the law of the iterated logarithm (LIL). Thus we propose the following weak LIL test for random sequences.

Weak LIL Test: Let α ∈ (0, 0.25] and N ⊂ N be a subset of natural numbers, we say that a sequence ξ fails the weak (α, N)-LIL test if −1+α<Sₗᵢₗ(ξ [symbol] n)<1−α for all n ∈ N. Furthermore, P_{(α,N)} denotes the probability that a random sequence passes the weak (α, N)-LIL test, and E_{(α,N)} is the set of sequences that pass the weak (α, N)-LIL test.

By the afore mentioned definition, a sequence ξ passes the weak (α, N)-LIL test if Sₗᵢₗ reaches either 1−α or −1+α at some points in N. In practice, it is important to choose appropriate test point set and calculate the probability for a random sequence ξ to pass the weak (α, N)-LIL test. In this section we calculate the probability for a sequence to pass the weak (α, N)-LIL test with the following choices of N:

N₀={2⁰n₁}, . . . , Nₜ={2^{t}n₁}, and ∪Nᵢ

for given n₁ and l. Specifically, we can consider the cases for l=8 and n₁=2²⁶.
Theorem 4 Let x₁, . . . , xₜ ∈ {0, 1}ⁿ. Then we have

$${S}_{lil} ( {x}_{1} ) + … + {S}_{lil} ( {x}_{t} ) = {S}_{lil} ( {x}_{1} … {x}_{t} ) \cdot \sqrt{\frac{t ln ln ( tn )}{ln ln n}} \qquad ( 3 )$$

Proof By (1), we have

$$\begin{matrix}{S}_{lil} ( {x}_{1} ) + … + {S}_{lil} ( {x}_{t} ) = \frac{2 {\sum }_{i = 1}^{t} S ( {x}_{i} ) - tn}{\sqrt{2 n ln ln n}} \\ = \frac{2 \cdot S ( {x}_{1} … {x}_{t} ) - tn}{\sqrt{2 n ln ln n}} \\ = \frac{2 \cdot S ( {x}_{1} … {x}_{t} ) - tn}{\sqrt{2 \cdot tn ln ln tn}} \cdot \sqrt{\frac{t ln ln tn}{ln ln n}} \\ = {S}_{lil} ( {x}_{1} … {x}_{t} ) \cdot \sqrt{\frac{t ln ln ( tn )}{ln ln n}}\end{matrix} \qquad ( 4 )$$

Theorem 4 can be generalized as follows.

Theorem 5 Let x₁ ∈ {0,1 }^{sn} and x₂ ∈{0, 1}^{tn}. Then we have

Sₗᵢₗ(x₁)\sqrt{s ln ln(sn)}+Sₗᵢₗ(x₂)\sqrt{t ln ln(tn)}=Sₗᵢₗ(x₁x₂){square root over ((s+t)ln ln((s+t)n))} (5)

Proof. We first note that

Sₗᵢₗ(x₁)\sqrt{s ln ln(sn)}=(2·S(x₁)−sn)/\sqrt{2n} (6)

Sₗᵢₗ(x₂)\sqrt{t ln ln(tn)}=(2·S(x₂)=tn)/\sqrt{2n} (7)

By adding equations (6) and (7) together, we get (5). The theorem is proved.
Corollary 6 Let 0<θ<1 and 1≦s<t. For given ξ [symbol] sn with Sₗᵢₗ(ξ [symbol] sn)=ε and randomly chosen ξ[sn . . . tn−1],

$$Prob [ {S}_{lil} ( ξ ↾ tn ) \geq θ ] = Prob [ {S}^{*} ( ξ [ sn … tn - 1 ] ) \geq \sqrt{\frac{2}{t - s}} ( θ \sqrt{t ln ln tn} - ɛ \sqrt{s ln ln sn} ) ] \qquad ( 8 )$$

Proof. By Theorem 5, we have

Sₗᵢₗ(ξ[0 . . . tn−1])\sqrt{t ln ln tn}=Sₗᵢₗ(ξ[sn . . . tn−1])\sqrt{(t−s)ln ln(t−s)n}+ε\sqrt{s ln ln sn}. (9)

Thus Sₗᵢₗ(ξ[0 . . . tn−1])≧θ if, and only if,

$${S}_{lil} ( ξ [ sn … tn - 1 ] ) \geq \frac{θ \sqrt{t ln ln tn} - ɛ \sqrt{s ln ln sn}}{\sqrt{( t - s ) ln ln ( t - s ) n}} \qquad ( 10 )$$

By Lemma 3, (10) is equivalent to (11).

$${S}^{*} ( ξ [ sn … tn - 1 ] ) \geq \sqrt{\frac{2}{t - s}} ( θ \sqrt{t ln ln tn} - ɛ \sqrt{s ln ln sn} ) \qquad ( 11 )$$

In other words, (8) holds.

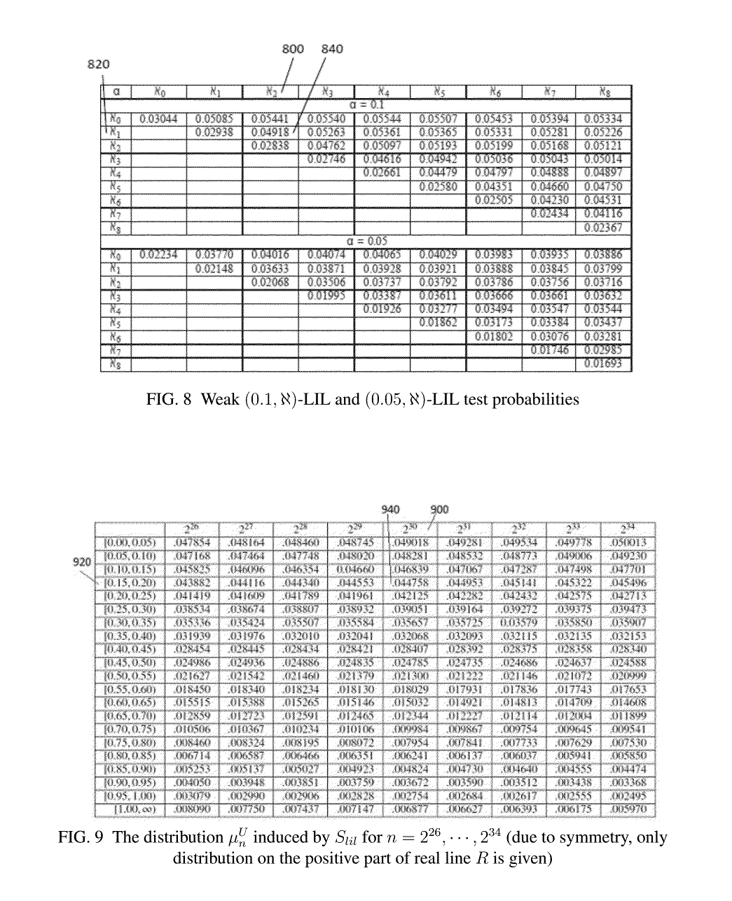

The afore mentioned Theorems, Lemmas, and Corollary could be used to calculate the probability for a random sequence to pass the weak (α, N)-LIL test. For α=0.1, α=0.05, and Nᵢ={2ⁱ⁺²⁶} with 0≦i≦8, the entry at (Nᵢ, Nᵢ) in FIG. 8 lists the probability P_{(α, N)} that a random sequence passes the weak (α, Nᵢ)-LIL test.

Now we consider the probability for a random sequence to pass the weak (α, N)-LIL test with N as the union of two Nᵢ. First we present the following Theorem.

Theorem 7 For fixed 0<α<1 and t≧2, let θ=1−α, N={n,tn}, Nₐ={n}, N_{b}={tn}. We have

$${P}_{( α , ℵ )} ≃ {P}_{( α , {ℵ}_{a} )} + \frac{1}{π} {\int }_{- θ \sqrt{2 lnln n}}^{θ \sqrt{2 lnln n}} {\int }_{\sqrt{\frac{1}{t - 1}} ( θ \sqrt{2 t lnln tn} - y )}^{∞} {e}^{- \frac{{x}^{2} + {y}^{2}}{2}} d x d y \qquad ( 12 )$$

Proof. Since E_{(α,N)}=E_{(α,N}_{ₐ}₎ ∪ E_{(α,N}_{_{b}}₎, we have P_{(α,N)}=P_{(α,N}_{ₐ})+P_{(α,N}_{_{b}}₎−P_{(α,N}_{ₐ}_{∩N}_{_{b}}₎, where

E_{(α,N}_{ₐ}_{∩N}_{_{b}}₎={ξ:|Sₗᵢₗ(ξ [symbol] n)|>θ [symbol] |Sₗᵢₗ(ξ [symbol] tn)|>θ}.

By symmetry, it suffices to show that

$$Prob [ {S}_{lil} ( ξ ↾ tn ) \geq θ \vert \overline{{E}_{( α , {ℵ}_{a} )}} ] ≃ \frac{1}{2 π} {\int }_{- θ \sqrt{2 lnln n}}^{θ \sqrt{2 lnln n}} {\int }_{\sqrt{\frac{1}{t - 1}} ( θ \sqrt{2 t lnln tn} - y )}^{∞} {e}^{- \frac{{x}^{2} + {y}^{2}}{2}} d x d y \qquad ( 13 )$$

Let Δ₁=\sqrt{2 ln ln n}·Δz. By Corollary 6, the probability that Sₗᵢₗ(ξ [symbol] n) ∈ [z, z+Δz] and Sₗᵢₗ(ξ [symbol] tn)>θ is approximately

$${\int }_{z \sqrt{2 lnln n}}^{z \sqrt{2 lnln n} + {Δ}_{1}} ϕ ( x ) d x {\int }_{\sqrt{\frac{2}{t - 1}} ( θ \sqrt{t lnln tn} - z \sqrt{lnln n} )}^{∞} ϕ ( x ) d x ≃ {Δ}_{1} \cdot ϕ ( z \sqrt{2 ln ln n} ) \cdot {\int }_{\sqrt{\frac{2}{t - 1}} ( θ \sqrt{t lnln tn} - z \sqrt{lnln n} )}^{∞} ϕ ( x ) d x \qquad ( 14 )$$

By substituting y=z\sqrt{2ln ln n} and integrating the equation (14) over the interval y ∈ [−0\sqrt{2 ln ln n}, 0\sqrt{2 ln ln n]}, we get the equation (13).

For α=0.1 (respectively α=0.05) and Nᵢ={2ⁱ⁺²⁶} with 0≦i<j≦8, the entry at (Nᵢ, Nⱼ) in FIG. 8 is the probability that a random sequence passes the weak (0.1, Nᵢ ∪ Nⱼ)-LIL test (respectively, (0.05, Nᵢ ∪ Nᵢ₊₁)-LIL test). Referring therefore to FIG. 8, cell 840 at the intersection of column 800 and row 820 contains the probability 0.04918 that a random sequence should pass the weak (N₁, N₂)-LIL test.

### Weak-LIL Test Design II

In the following, we consider the design of weak (α, N)-LIL test with consisting of at least three points. We use the following notations: N₀={2⁰n₁}, . . . , and Nₜ={2^{t}n₁} for given n₁ and t. In particular, we will consider the cases for n₁=2²⁶.

We first present the following Theorem.

Theorem 8 For fixed 0<α<1 and t₁, t₂>2, let θ=1−α, N={n, t₁n, t₁t₂n}, and Nₐ={n, t₁n}. Then we have

$${P}_{( α , ℵ )} ≃ {P}_{( α , {ℵ}_{a} )} + \frac{1}{2 π \sqrt{2 π ( {t}_{1} - 1 )}} {\int }_{{C}_{1}}^{ } {\int }_{{C}_{2}}^{ } {\int }_{{C}_{3}}^{ } {e}^{- \frac{{x}^{2} + {y}^{2}}{2} - \frac{{( z - y )}^{2}}{2 ( {t}_{1} - 1 )}} d x d y d z \\ where \\ {C}_{1} = [ - θ \sqrt{2 {t}_{1} ln ln {t}_{1} n} , θ \sqrt{2 {t}_{1} ln ln {t}_{1} n} ] \\ {C}_{2} = [ - θ \sqrt{2 ln ln n} , θ \sqrt{2 ln ln n} ] \\ {C}_{3} = [ \sqrt{\frac{1}{{t}_{2} - 1}} ( θ \sqrt{2 {t}_{2} ln ln {t}_{2} {t}_{1} n} - z / \sqrt{{t}_{1}} ) , ∞ ) . \qquad ( 15 )$$

Proof. By symmetry, it suffices to show that

$$Prob [ {S}_{lil} ( ξ ↾ {t}_{1} {t}_{2} n ) \geq θ \vert \overline{{E}_{( α , {ℵ}_{a} )}} ] ≃ \frac{1}{2 π \sqrt{2 π ( {t}_{1} - 1 )}} {\int }_{{C}_{1}}^{ } {\int }_{{C}_{2}}^{ } {\int }_{{C}_{3}}^{ } {e}^{- \frac{{x}^{2} + {y}^{2}}{2} - \frac{{( z - y )}^{2}}{2 ( {t}_{1} - 1 )}} d x d y d z \qquad ( 16 )$$

By Corollary 6, the probability that Sₗᵢₗ(ξ [symbol] t₁n) ∈ [z, z+Δz] and Sₗᵢₗ(ξ [symbol] t₁t₂n)>θ is approximately

$${P}_{( z , Δ z , {t}_{1} n )} \cdot {\int }_{\sqrt{\frac{2}{{t}_{2} - 1}} ( θ \sqrt{{t}_{2} lnln {t}_{2} {t}_{1} n} - z \sqrt{lnln {t}_{1} n} )}^{∞} ϕ ( x ) d x \qquad ( 17 )$$

where P_{(z,Δz,t}_{₁}ₙ₎ is the probability that Sₗᵢₗ(ξ [symbol] t₁n) ∈ [z, z+Δz].

Let Δ₁=\sqrt{2t₁ ln ln t₁n}·Δz. By equation (13) in the proof of Theorem 7, the probability P_{(z,Δz,t}_{₁}ₙ₎ under the conditional event “|Sₗᵢₗ(ξ [symbol] n)|<θ” is approximately

$$\begin{matrix}P ( z , Δ z , {t}_{1} n ) ≃ \frac{1}{2 π} {\int }_{{C}_{2}}^{ } {\int }_{\frac{z \sqrt{2 {t}_{1} ln ln {t}_{1} n} - y}{\sqrt{{t}_{1} - 1}}}^{\frac{z \sqrt{2 {t}_{1} ln ln {t}_{1} n} + {Δ}_{1} - y}{\sqrt{{t}_{1} - 1}}} {e}^{- \frac{{x}^{2} + {y}^{2}}{2}} d x d y \\ ≃ {\int }_{{C}_{2}}^{ } ϕ ( y ) ϕ ( \frac{z \sqrt{2 {t}_{1} ln ln {t}_{1} n} - y}{\sqrt{{t}_{1} - 1}} ) \frac{{Δ}_{1}}{\sqrt{{t}_{1} - 1}} d y \\ ≃ \frac{{Δ}_{1}}{\sqrt{{t}_{1} - 1}} {\int }_{{C}_{2}}^{ } ϕ ( y ) \cdot ϕ ( \frac{z \sqrt{2 {t}_{1} ln ln {t}_{1} n} - y}{\sqrt{{t}_{1} - 1}} ) d y\end{matrix} \qquad ( 18 )$$

By substituting (18) into (17), replacing z\sqrt{2t₁ln ln t₁n} with w, and integrating the obtained equation (18) over the interval w ∈ [−θ\sqrt{2t₁ ln ln t₁n}, θ\sqrt{2t₁ ln ln t₁n}], and finally replacing the variable w back to z, equation (16) is obtained. The theorem is then proved.

An an example, let n₁=2²⁶. We can calculate the following probabilities: P_{(0.1,N}_{₀}_{∪N}_{₃}_{∪N}_{₆}₎=0.07755, P_{(0.1,N}_{₀}_{∪N}_{₃}_{∪N}_{₈}₎=0.07741, P_{(0.1,N}_{₀}_{∪N}_{₆}_{∪N}_{₈}₎=0.07417, and P_{(0.1,N}_{₃}_{∪N}_{₆}_{∪N}_{₈}₎=0.06995. By trying all different combinations, it can be shown that for any N=Nᵢ_{₁} ∪ Nᵢ_{₂} ∪Nᵢ_{₃} with different 0≦i₁, i₂, i₃≦8, we have 0.069≦P_{0.1,N}≦0.08 and 0.05≦P_{0.05,N}≦0.06.

### An Alternative Approach for Calculating Weak LIL Tests Probability

In the following, we give an alternative approach to approximate the probability P_{(α,N)} with |N|>3.

We show the approximation technique with the example of α=0.1 and N=N₀ ∪ N₃ ∪N₆ ∪ N₈. First we note that

P_{(α,N)}32 P_{(α,N}_{₀}_{∪N}_{₃}_{∪N}_{₆}₎+P_{(α,N}_{₈}₎−Prob[E_{(α,N}_{₈}₎ ∩ E_{(α,N}_{₀}_{∪N}_{₃}_{∪N}_{₆}₎]

Since

E_{(α,N}_{₈}₎ ∩ E_{(α,N}_{₀}_{∪N}_{₃}_{∪N}_{₆}₎=(E_{(α,N}_{₈}₎ ∩ E_{(α,N}_{₃}₎) ∪ (E_{(α,N}_{₈}₎ ∩E_{(α,N}_{₆}₎)

we have

$$Prob [ {E}_{( α , {ℵ}_{8} )} ⋂ {E}_{( α , {ℵ}_{0} ⋃ {ℵ}_{3} ⋃ {ℵ}_{6} )} ] = Prob [ {E}_{( α , {ℵ}_{0} )} ⋂ {E}_{( α , {ℵ}_{8} )} ] + Prob [ {E}_{( α , {ℵ}_{3} )} ⋂ {E}_{( α , {ℵ}_{8} )} ] + Prob [ {E}_{( α , {ℵ}_{6} )} ⋂ {E}_{( α , {ℵ}_{8} )} ] - Prob [ {E}_{( α , {ℵ}_{0} )} ⋂ {E}_{( α , {ℵ}_{3} )} ⋂ {E}_{( α , {ℵ}_{8} )} ] - Prob [ {E}_{( α , {ℵ}_{0} )} ⋂ {E}_{( α , {ℵ}_{6} )} ⋂ {E}_{( α , {ℵ}_{8} )} ] - Prob [ {E}_{( α , {ℵ}_{3} )} ⋂ {E}_{( α , {ℵ}_{6} )} ⋂ {E}_{( α , {ℵ}_{8} )} ] + 2 \cdot Prob [ {E}_{( α , {ℵ}_{0} )} ⋂ {E}_{( α , {ℵ}_{3} )} ⋂ {E}_{( α , {ℵ}_{6} )} ⋂ {E}_{( α , {ℵ}_{8} )} ]$$

Let ε=Prob[E_{(α,N}_{₀}₎ ∩E_{(α,N}_{₃}₎ ∩E_{(α,N}_{₆}₎ ∩ E_{(α,N}_{₈}₎]. By substitution and simplifying, we get

$${P}_{( α , ℵ )} = {\sum }_{i ∈ \{ 0 , 3 , 6 , 8 \}}^{ } {P}_{( α , {ℵ}_{i} )} + {\sum }_{{i}_{1} , {i}_{2} , {i}_{3} ∈ \{ 0 , 3 , 6 , 8 \}}^{ } {P}_{( α , {ℵ}_{{i}_{1}} ⋃ {ℵ}_{{i}_{2}} ⋃ {ℵ}_{{i}_{3}} )} - {\sum }_{{i}_{1} , {i}_{2} ∈ \{ 0 , 3 , 6 , 8 \}}^{ } {P}_{( α , {ℵ}_{{i}_{1}} ⋃ {ℵ}_{{i}_{2}} )} - 2 ɛ ≃ 0.09662 - 2 ɛ \qquad ( 19 )$$

On the other hand, we have

$$2 ɛ < 2 \cdot Prob [ {E}_{( α , {ℵ}_{3} )} ⋂ {E}_{( α , {ℵ}_{6} )} ⋂ {E}_{( α , {ℵ}_{8} )} ] = {P}_{( α , {ℵ}_{3} ⋃ {ℵ}_{6} ⋃ {ℵ}_{8} )} + {\sum }_{i ∈ \{ 3 , 6 , 8 \}}^{ } {P}_{( α , {ℵ}_{i} )} - {\sum }_{{i}_{1} , {i}_{2} ∈ \{ 3 , 6 , 8 \}}^{ } {P}_{( α , {ℵ}_{{i}_{1}} ⋃ {ℵ}_{{i}_{2}} )} ≃ 0.00032$$

Thus we have 0.09630<P_{(α,N)}<0.09662. In other words, a random sequence passes the weak (0.1, N₀ ∪ N₃ ∪N₆ ∪N₈) -LIL test with approximately 9.65% probability.

### Strong LIL Test Design

We now consider the following strong LIL tests:

Strong LIL Test: Let α∈ (0, 0.25] and Nₐ, N_{b}, N_{c} ⊂ N be subsets of natural numbers. We say that a sequence ξ passes the strong (α; Nₐ, N_{b})-LIL test if there exist n₁ ∈ Nₐ and n₂ ∈ N_{b} such that

|Sₗᵢₗ(ξ [symbol] nᵢ)|>1−α for i=1, 2; and Sₗᵢₗ(ξ [symbol] n₁)Sₗᵢₗ(ξ [symbol] n₂)<0. (20)

Alternatively, we say that a sequence ξ passes the strong (α; N_{c})-LIL test if there exist n₁, n₂ ∈ N_{c} such that (20) holds. Furthermore, SP_{(α;N}_{ₐ}_{,N}_{_{b}}₎ and SP_{(α;N}_{_{c}}₎ denote the probability that a randomly chosen sequence passes the strong (α; Nₐ, N_{b})-LIL and (α; N_{c})-LIL tests respectively.
Theorem 9 For fixed 0<α<1 and t≧2, let θ=1−α, Nₐ={n}, and N_{b}={tn}. We have

$${SP}_{( α , {ℵ}_{a} , {ℵ}_{b} )} ≃ \frac{1}{π} {\int }_{θ \sqrt{2 ln ln n}}^{∞} {\int }_{- ∞}^{- \sqrt{\frac{1}{t - 1}} ( θ \sqrt{2 t ln ln tn} + y )} {e}^{- \frac{{x}^{2} + {y}^{2}}{2}} d x d y \qquad ( 21 )$$

Proof. The theorem could be proved in a similar way as in the proof of Theorem 7.

As an example, let α=0.1, N₀={2²⁶}, N₇={2³³}, and N₈={2³⁴}. Then we have SP_{(α,N}_{₀}_{,N}_{₇}₎ ˜ 0.0001981 and SP_{(α,N}_{₀}_{,N}_{₈}₎ ˜ ̂ 0.0002335

In the following, we provide another approach for obtaining better probability bounds for strong LIL tests. In a negative binomial distribution f (k; r, ½) denote the probability that the rth one appears at the position r+k. It is well known that for this distribution, we have mean μ=r and variance σ=\sqrt{2r}. Thus the probability that the r's one appears before the nth position is approximated by the following probability:

$$\frac{1}{2 \sqrt{r π}} {\int }_{- ∞}^{n} {e}^{- \frac{{( x - 2 r )}^{2}}{4 r}} d x \qquad ( 22 )$$

For n₁=2²⁶ and n₂=2³⁴, assume that Sₗᵢₗ(ξ [symbol] n₁)≦−y for given y≧θ. Then we have

$$S ( ξ ↾ {n}_{1}^{ } ) \leq \frac{{n}_{1} = y \sqrt{2 {n}_{1} ln ln {n}_{1}}}{2} \qquad ( 23 )$$

By (23), in order for Sₗᵢₗ(ξ [symbol] n₂)≧θ, we need to have

$$r ( y ) = S ( ξ [ {n}_{1} … {n}_{2} - 1 ] ) \geq \frac{{n}_{2} + θ \sqrt{2 {n}_{2} ln ln {n}_{2}} - {n}_{1} + y \sqrt{2 {n}_{1} ln ln {n}_{1}}}{2}$$

Let α=1−θ, Nₐ={n₁}, and N_{b}={n₂}. Using the same argument as in the proof of Theorem 7 (in particular, the arguments for integrating equation (14)) and the negative binomial distribution equation (22), the probability that a sequence passes the strong (α; Nₐ, N_{b})-LIL test can be calculated with the following equation.

$$\frac{1}{π} {\int }_{- ∞}^{- θ \sqrt{2 ln ln {n}_{1}}} {\int }_{- ∞}^{{n}_{2} - {n}_{1}} \frac{1}{\sqrt{2 r ( y )}} {e}^{- \frac{{y}^{2}}{2} - \frac{{( x - 2 r ( y ) )}^{2}}{4 r ( y )}} d x d y \qquad ( 24 )$$

By substituting the values of θ, n₁, and n₂, (24) evaluates to 0.0002335. In other words, a random sequence passes the strong (0.1; N₀, N₈)-LIL test with probability 0.023%

Both (21) and (24) could be used to calculate the probability for strong LIL tests. These equations could be used to generalize results to cases of strong (α; Nₐ, N_{b})-LIL test with multiple points in N_{b}.

### Evaluating Pseudorandom Generators

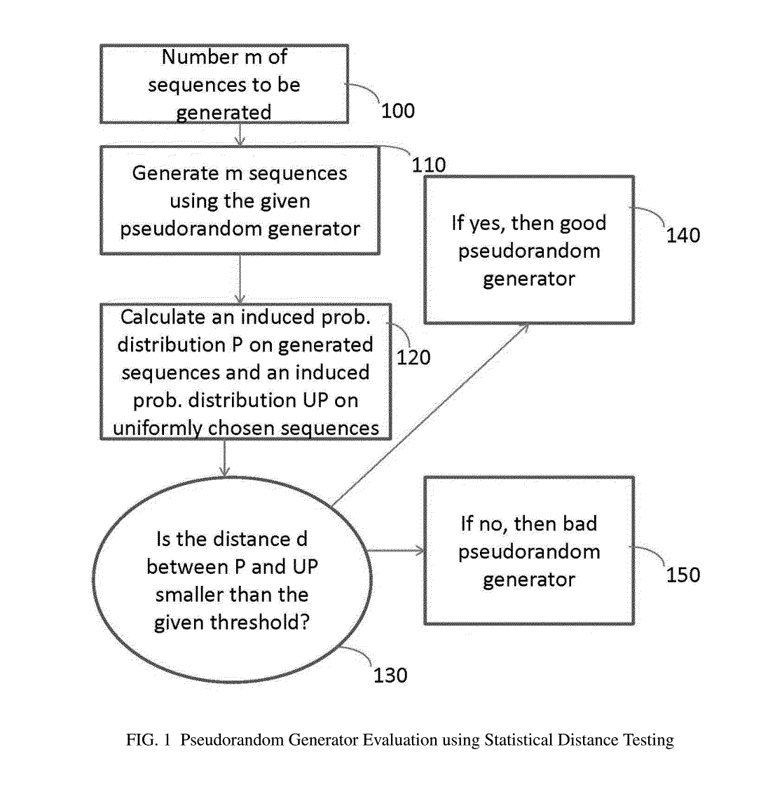

FIG. 1 describes a general process for evaluating the quality of pseudorandom generators. Referring therefore to FIG. 1, a size selector 100 chooses the number m of sequences to be generated. A generator 110 is then used to generate Tri, sequences of the given length. The process 120 calculates the induced statistical distribution P on the generated m sequences according to the statistical law. Similarly, the process 120 also calculates the induced statistical distribution UP on the uniformly chosen sequences according to the statistical law. A distance comparison process 130 compares the statistical distance between the two distributions P and UP. If the distance is smaller than a given threshold, the generator is classified as a good generator 140. If the distance is larger than the given threshold, the generator is classified as a bad generator 150.

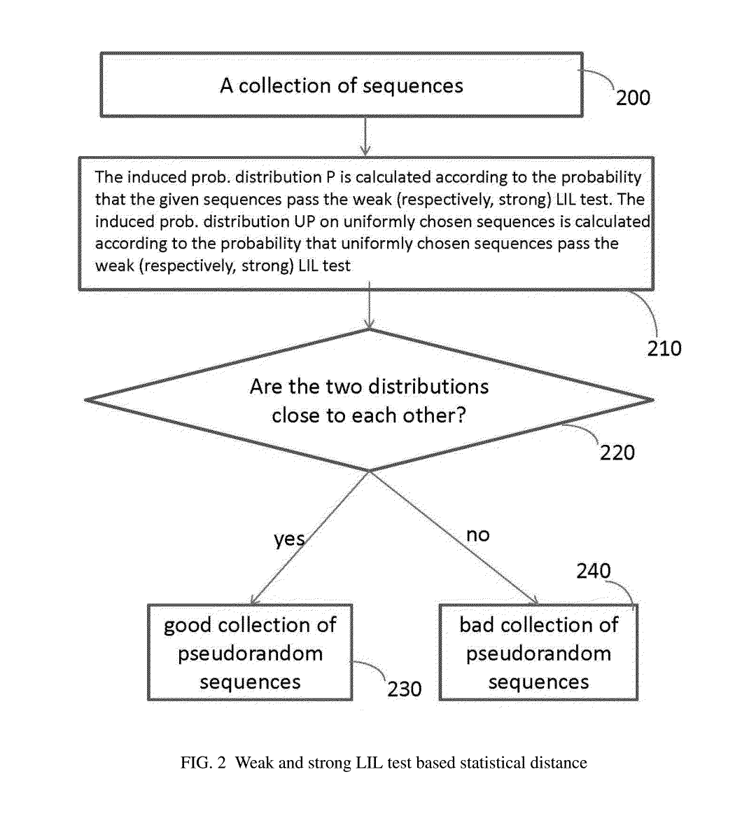

FIG. 2 describes a process of calculating the distributions P and UP which are based on weak and strong LIL tests. Referring therefore to FIG. 2, a generated sequence collection 200 is given to an induced distribution calculator 210 to derive the induced probability distributions P and UP. A probability distance process 220 compares the two induced probability distributions. If the distance is smaller than a given threshold, the sequence collection 200 is classified as good 230. If the distance is larger than the given threshold, the sequence collection 200 is classified as bad 240.

In the following, we provide the embodiment of this process for weak LIL test. In order to evaluate the quality of a pseudorandom generator G, We first choose a fixed n of sequence length, a value 0<α≦0.1, and mutually distinct subsets N₀, . . . , Nₜ of {1, . . . , n}. It is preferred that the Sₗᵢₗ values on these subsets are as independent as possible (though they are impossible to be independent). Then we can carry out the following steps.
1. Set

$${P}_{( α , ℵ )}^{+} = {P}_{( α , ℵ )}^{-} = \frac{1}{2} {P}_{( α , ℵ )}$$

### for all N.

2. Use G to construct a set of m≧1000 binary sequences of length n.
3. For each calculate probability P_{(α,N)}^{|} that these sequences pass the weak (α, Nᵢ)-LIL test via Sₗᵢₗ≧1−α (respectively, P_{(α,N)}⁻ for Sₗᵢₗ≦−1+α).
4. Calculate the average absolute probability distance

$${Δ}_{wlil} = \frac{1}{t + 1} {\sum }_{i = 0}^{t} {P}_{( α , {ℵ}_{i} )}^{- 1} ( \vert {P}_{( α , {ℵ}_{i} )}^{+} - {P}_{( α , {ℵ}_{i} )}^{+} \vert + \vert {P}_{( α , {ℵ}_{i} )}^{-} - {P}_{( α , {ℵ}_{i} )}^{-} \vert )$$

and the root-mean-square deviation

$${RMSD}_{wlil} = \sqrt{\frac{{\sum }_{0 \leq i \leq j \leq t}^{ } ( {p}_{i , j , 1}^{2} + {p}_{i , j , 2}^{2} )}{( t + 1 ) ( t + 2 )}}$$

where p_{i,j,1}⁺=P_{(α,N}_{ᵢ}_{∪N}_{ⱼ}₎⁺−P_{(α,N}_{ᵢ}_{∪N}_{ⱼ}₎⁺and p_{i,j,2}⁺=P_{(α,N}_{ᵢ}_{∪N}_{ⱼ}₎⁻−P_{(α,N}_{ᵢ}_{∪N}_{ⱼ}₎⁻
5. Decision criteria: the smaller Δ_{wlil} and RMSD_{whil}, the better generator G.

### Snapshot LIL Tests and Random Generator Evaluation

We have considered statistical tests based on the limit theorem of the law of the iterated logarithm. These tests do not take full advantage of the distribution Sₗᵢₗ, which defines a probability measure on the real line R. Let Rₙ ⊂ Σⁿ be a set of m sequences with a standard probability definition on it. That is, for each x₀ ∈ Rₙ, let Prob[x=x₀]=1/m. Then each set Rₙ ⊂ Σⁿ induces a probability measure μₙ^{R}^{ₙ} on Rₙ by letting

μₙ^{R}^{ₙ}(I)=Prob[Sₗᵢₗ(x) ∈ I, x ∈ Rₙ]

for each Lebesgue measurable set I on R. For U=Σⁿ, we use μₙ^{U} to denote the corresponding probability measure induced by the uniform distribution. By the definition, if Rₙ is the collection of all length n sequences generated by a pseudorandom generator, then the difference between μₙ^{U} and μₙ^{R}^{ₙ} is negligible.

For a uniformly chosen ξ, the distribution of S*(ξ [symbol] n) could be approximated by a normal distribution of mean 0 and variance 1, with error bounded by 1/n. In other words, the measure μₙ^{U} can be calculated as

μₙ^{U}((−∞, x]) ˜ Φ(x\sqrt{2ln ln n})=\sqrt{2ln ln n}∫_{-∞}^{∞}φ(y\sqrt{2ln ln n})dy.

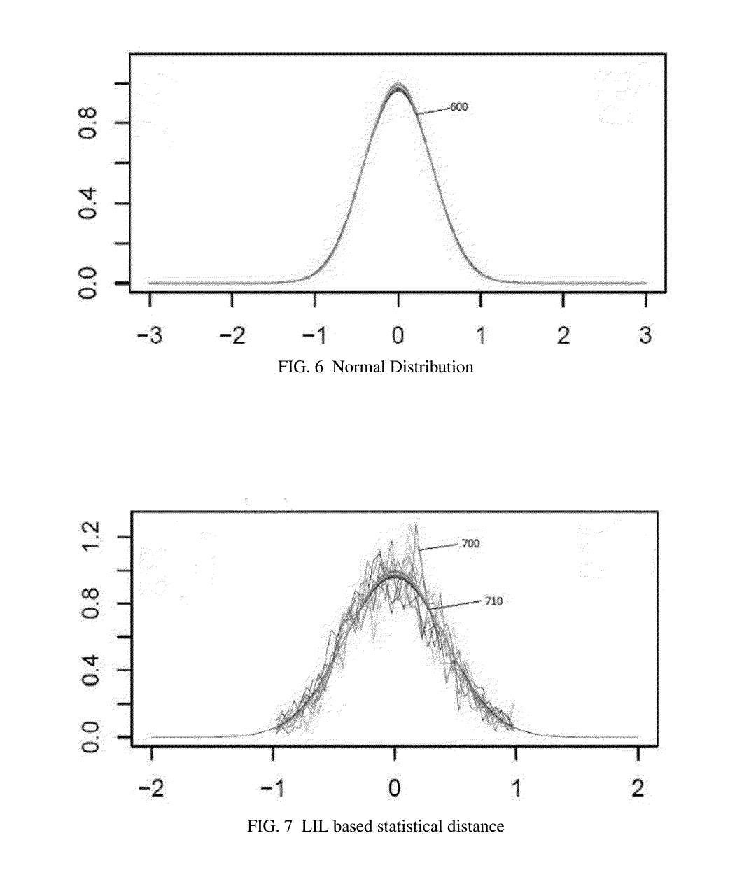

Curve 600 in FIG. 6 shows the distributions of μₙ^{U} for n=2²⁶, . . . , 2³⁴ and FIG. 9 lists values μₙ^{U}(I) on B with n=2²⁶, . . . , 2³⁴. Since μₙ^{U}(I) is symmetric, it is sufficient to list the distribution in the positive side of the real line. Referring therefore to FIG. 9, the value 0.044758 in cell 940 at the intersection of column 900 and row 920 is the probability that a random sequence ξ has the LIL value Sₗᵢₗ(ο[0 . . . n−1]) contained in the interval [0.15, 0.20] at the point 2³⁰.

In order to evaluate a pseudorandom generator G, first choose a sequence of testing points n₀, . . . , nₜ (e.g., n₀=2^{26+t}). Secondly use G to generate sets Rₙ_{ᵢ} ⊂ Σⁿ^{ᵢ} of m sequences for 0≦i≦t. Lastly compare the distances between the two probability measures μₙ^{R}^{ₙ} and μₙ^{U} for n=n₀, . . . , nₜ.

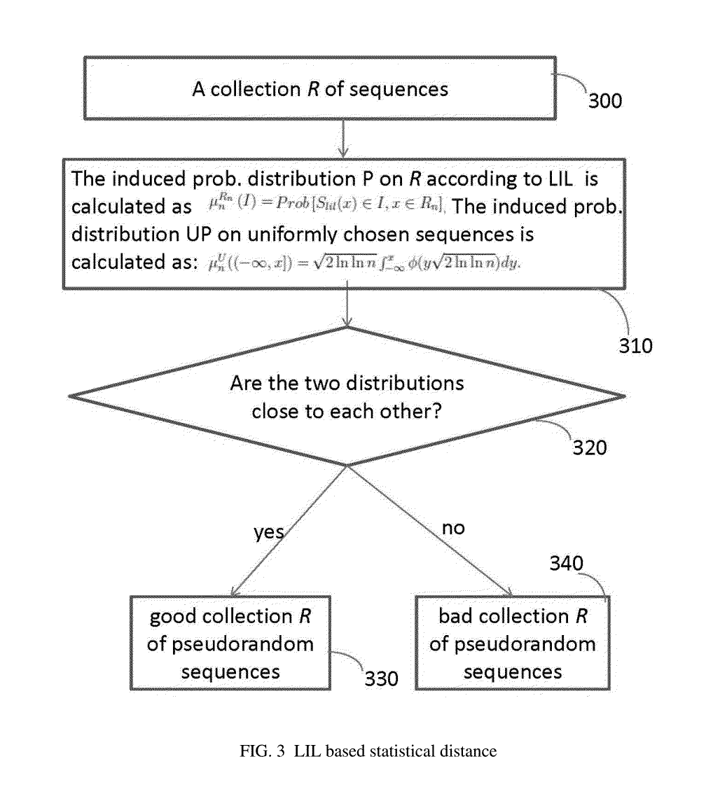

FIG. 3 describes a process of evaluating the quality of pseudorandom generators based on the LIL induced distribution and the normal distribution. Referring therefore to FIG. 3, a generated sequence collection 300 is given to an induced LIL distribution calculator 310 to derive the induced probability distributions P and UP. A probability distance process 320 compares the induced LIL probability P against the normal distribution UP. If the distance is smaller than a given threshold, the sequence collection 300 is classified as good 330. If the distance is larger than the given threshold, the sequence collection 300 is classified as bad 340.

A generator G is considered “good”, if for sufficiently large m, the distances between μₙ^{R} and μₙ^{U} are negligible (or smaller than a given threshold). There are various definitions of statistical distances for probability measures. In this invention, we will consider the total variation distance in Clarkson and Adams (1933)

$$d ( {μ}_{n}^{R} , {μ}_{n}^{U} ) = {sup}_{A ⊆ B} \vert {μ}_{n}^{R} ( A ) - {μ}_{n}^{U} ( A ) \vert$$

Hellinger distance in Hellinger (1909)

$$H ( {μ}_{n}^{R} \vert \vert {μ}_{n}^{U} ) = \frac{1}{\sqrt{2}} \sqrt{{\sum }_{A ∈ B}^{ } {( \sqrt{{μ}_{n}^{R} ( A )} - \sqrt{{μ}_{n}^{U} ( A )} )}^{2}}$$

and the root-mean-square deviation

$$RMSD ( {μ}_{n}^{R} , {μ}_{n}^{U} ) = \sqrt{\frac{{\sum }_{A ∈ B}^{ } {( \sqrt{{μ}_{n}^{R} ( A )} - \sqrt{{μ}_{n}^{U} ( A )} )}^{2}}{42}}$$

where B is a partition of the real line R that is defined as

{(∞, 1), [1, ∞)} ∪ {[0.05x−1, 0.05x−0.95):0≦x≦39}.

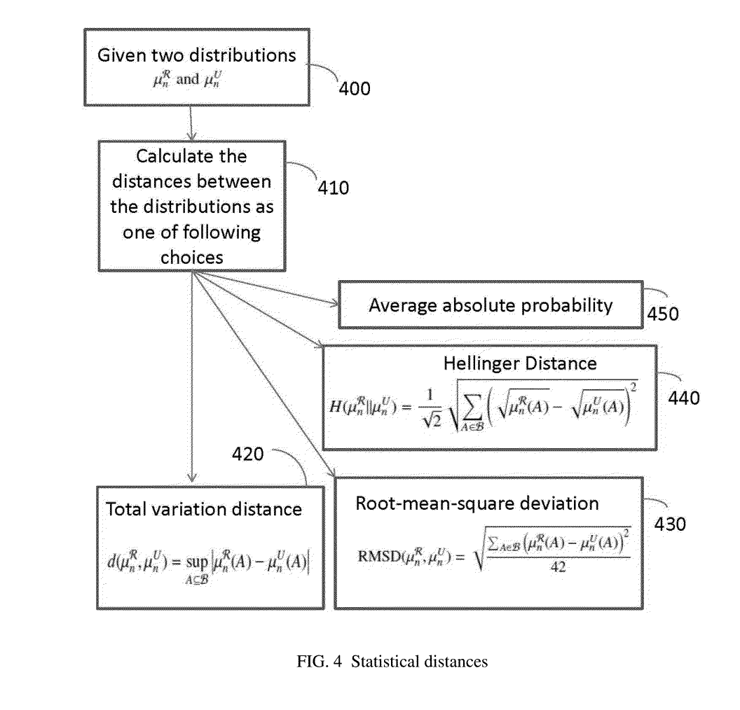

Referring therefore to FIG. 4, the distance of two given distributions 400 are calculated via a distance calculation process 410 using one of the afore mentioned methods: total variation distance 420, root-mean-square deviation 430, Hellinger distance 440, and average absolute probability distance 450.

### Experimental Results

We carried out weak LIL test experiments on pseudorandom generators SHA1PRNG (Java) and NIST DRBG in Barker and Kelsey (2012) with parameters α=0.1 (and 0.05) and N₀={2²⁶}, . . . , N₈={2³⁴} (note that 2²⁶ bits=8 MB and 2³⁴ bits=2 GB).

For a given optional seeding string s of arbitrary length, the pseudorandom generator SHA1PRNG API in Java generates a sequence SHA1′(s, 0)SHA1′(s, 1) . . . , where the counter i is 64 bits long, and SHA1′(s, i) is the first 64 bits of SHA1(s, i). In the experiment, we generated one thousand of sequences with four-byte seeds of integers 0, 1, 2, . . . , 999 respectively. For each sequence generation, the “random.nextBytes( )” method of SecureRandom Class is called 2²⁶ times and a 32-byte output is requested for each call. This produces sequences of 2³⁴ bits long.

TABLE 1
Number of sequences that pass the LIL values 0.9 and 0.95

| N | N₀ | N₁ | N₂ | N₃ | N₄ | N₅ | N₆ | N₇ | N₈ |
|---|---|---|---|---|---|---|---|---|---|
| n | 82 | 116 | 164 | 232 | 328 | 463 | 655 | 927 | 1310 |

Java SHA1PRNG

| | | | | | | | | | |
|---|---|---|---|---|---|---|---|---|---|
| 0.9 | 20 | 16 | 20 | 20 | 16 | 14 | 17 | 11 | 11 |
| −0.9 | 18 | 20 | 18 | 17 | 14 | 11 | 12 | 11 | 9 |
| 0.95 | 14 | 12 | 13 | 18 | 12 | 10 | 15 | 7 | 8 |
| −0.95 | 13 | 13 | 14 | 9 | 10 | 7 | 9 | 8 | 6 |

NIST SP800 90A SHA1-DRBG at sample size 1000

| | | | | | | | | | |
|---|---|---|---|---|---|---|---|---|---|
| 0.9 | 15 | 16 | 15 | 12 | 8 | 9 | 17 | 10 | 8 |
| −0.9 | 15 | 19 | 12 | 18 | 10 | 16 | 14 | 9 | ′2 |
| 0.95 | 10 | 9 | 12 | 10 | 5 | 5 | 11 | 6 | 6 |
| −0.95 | 11 | 12 | 8 | 13 | 8 | 10 | 10 | 7 | 12 |

NIST SP800 90A SHA256-DRBG at sample size 1000

| | | | | | | | | | |
|---|---|---|---|---|---|---|---|---|---|
| 0.9 | 13 | 16 | 14 | 20 | 13 | 15 | 21 | 16 | 9 |
| −0.9 | 16 | 13 | 14 | 5 | 13 | 9 | 11 | 13 | 10 |
| 0.95 | 9 | 10 | 12 | 15 | 9 | 10 | 16 | 14 | 3 |
| −0.95 | 13 | 9 | 8 | 4 | 8 | 6 | 9 | 12 | 9 |

NIST SP800 90A SHA256-DRBG at sample size 10000

| | | | | | | | | | |
|---|---|---|---|---|---|---|---|---|---|
| 0.9 | 164 | 157 | 162 | 145 | 128 | 128 | 133 | 121 | 114 |
| −0.9 | 154 | 142 | 142 | 130 | 123 | 128 | 123 | 120 | 107 |
| 0.95 | 120 | 107 | 127 | 110 | 89 | 93 | 93 | 84 | 70 |
| −0.95 | 107 | 106 | 92 | 99 | 91 | 93 | 95 | 84 | 78 |

NIST SP800.90A in Barker and Kelsey (2012) specifies three types of DRBG generators: hash function based, block cipher based, and ECC based. In our experiments, we used hash function based DRBG. where a hash function G is used to generate sequences G(V)G(V+1)G(V+2) . . . with V being seedlen-bit counter that is derived from the secret seeds. The seedlen is 440 for SHA 1 and SHA-256 and the value of V is revised after at most 2¹⁹ bits are output.

We generated 10000 sequences nistSHADRBG0, . . . , nistSHADRBG9999. For each sequence nistSHADRBGi, the seed “ith secret seed for NIST DRBG” is used to derive the initial DRBG state V₀ and C₀. Each sequence is of the format G(V₀)G(V₀) . . . G(V₀+2¹²−1)G(V₁)G(V₁+1) . . . G(V₂²⁵2¹²−1), where Vᵢ₊₁ is derived from the value of Vᵢ and Cᵢ. In other words, each V is used 2¹² times before it is revised.

Table 1 shows the number of sequences that reach the value 0.9, −0.9, 0.95, and −0.95 at corresponding testing points respectively.

Table 2 lists values μₙ^{nistDRBsha1}(I) on B with n=2²⁶, . . . , 2³⁴.

Table 3 lists values μₙ^{nistDRBGsha256,1000}(I) on B with n=2²⁶, . . . , 2³⁴. The distribution μₙ^{nistDRBGsha256,1000}(I) is compared against the normal distribution in FIG. 7. Referring therefore to FIG. 7, curve 710 is a curve for the normal distribution and curves 700 are the curves for the distribution μₙ^{nistDRBGsha256,1000}(I).

Table 4 lists values μₙ^{nistDRBGsha256,10000}(I) on B with n=2²⁶, . . . , 2³⁴.

Table 5 lists values μₙ^{JavaSHA1}(I) on B with n=2²⁶, . . . , 2³⁴.

Based on Table 1, the average absolute probability distance Δ_{wlil} and the root-mean-square deviation RMSD_{wlil} at the sample size 1000 (for DRBG-SHA256, we also include results for sample size 10000) are calculated and shown in Table 6.

Based on snapshot LIL tests at points 2²⁶, . . . , 2³⁴, the corresponding total variation distance d(μₙ^{R}, μₙ^{U}), Hellinger distance H(μₙ^{R}∥μₙ^{U}), and the root-mean-square deviation RMSD(μₙ^{R}, μₙ^{U}) at sample size 1000 (also DRBG-SHA256 at sample size 10,000) are calculated and shown in Table 7, where subscripts 1, 2, 3, 4 are for JavaSHA1, nistDRBGsha1, nistDRBGsha256 (sample size 1000), and nistDRBGsha256 (sample size 10000) respectively. It is observed that at the sample size 1000, the average distance between μₙ^{R} and μₙ^{U} is larger than 0.06.

TABLE 2
The distribution μₙ^{nistDRBGsha1} induced by Sₗᵢₗ for
n = 2²⁶, . . . , 2³⁴ (sample size 1000)

| | 2²⁶ | 2²⁷ | 2²⁸ | 2²⁹ | 2³⁰ | 2³¹ | 2³² | 2³³ | 2³⁴ |
|---|---|---|---|---|---|---|---|---|---|
| (−∞, −1) | .009 | .008 | .007 | .008 | .006 | .007 | .007 | .006 | .007 |
| [−0.1, −0.95) | .002 | .004 | .001 | .005 | .002 | .003 | .003 | .001 | .005 |
| [−0.95, −0.90) | .004 | .007 | .004 | .005 | .002 | .006 | .004 | .002 | .000 |
| [−0.90, −0.85) | .009 | .006 | .011 | .008 | .005 | .003 | .006 | .006 | .009 |
| [−0.85, −0.80) | .005 | .010 | .004 | .010 | .008 | .003 | .004 | .010 | .003 |
| [−0.80, −0.75) | .007 | .004 | .010 | .011 | .006 | .008 | .011 | .005 | .002 |
| [−0.75, −0.70) | .009 | .005 | .014 | .008 | .011 | .017 | .007 | .013 | .011 |
| [−0.70, −0.65) | .019 | .014 | .014 | .011 | .026 | .015 | .012 | .013 | .009 |
| [−0.65, −0.60) | .013 | .020 | .010 | .012 | .018 | .011 | .014 | .012 | .011 |
| [−0.60, −0.55) | .016 | .021 | .019 | .014 | .019 | .022 | .021 | .018 | .017 |
| [−0.55, −0.50) | .022 | .018 | .022 | .027 | .028 | .022 | .023 | .023 | .023 |
| [−0.50, −0.45) | .027 | .025 | .020 | .033 | .021 | .029 | .025 | .026 | .034 |
| [−0.45, −0.40) | .028 | .030 | .024 | .027 | .025 | .033 | .034 | .028 | .035 |
| [−0.40, −0.35) | .030 | .036 | .031 | .026 | .027 | .026 | .037 | .041 | .036 |
| [−0.35, −0.30) | .041 | .032 | .037 | .035 | .032 | .026 | .040 | .039 | .038 |
| [−0.30, −0.25) | .034 | .043 | .052 | .038 | .039 | .032 | .034 | .032 | .048 |
| [−0.25, −0.20) | .045 | .031 | .048 | .038 | .038 | .046 | .036 | .030 | .044 |
| [−0.20, −0.15) | .055 | .044 | .048 | .039 | .039 | .042 | .046 | .051 | .050 |
| [−0.15, −0.10) | .056 | .058 | .046 | .046 | .041 | .050 | .046 | .050 | .042 |
| [−0.10, −0.05) | .046 | .048 | .048 | .044 | .044 | .051 | .046 | .059 | .039 |
| [−0.05, 0) | .045 | .050 | .035 | .051 | .040 | .053 | .048 | .059 | .048 |
| [0, 0.05) | .045 | .040 | .051 | .052 | .047 | .041 | .033 | .044 | .042 |
| [0.05, 0.10) | .058 | .038 | .060 | .047 | .056 | .044 | .044 | .056 | .051 |
| [0.10, 0.15) | .042 | .044 | .035 | .041 | .057 | .047 | .050 | .040 | .048 |
| [0.15, 0.20) | .037 | .040 | .040 | .051 | .039 | .049 | .045 | .038 | .033 |
| [0.20, 0.25) | .034 | .050 | .037 | .056 | .045 | .039 | .046 | .039 | .033 |
| [0.25, 0.30) | .042 | .041 | .034 | .046 | .042 | .032 | .037 | .039 | .035 |
| [0.30, 0.35) | .036 | .036 | .040 | .035 | .036 | .031 | .043 | .037 | .040 |
| [0.35, 0.40) | .022 | .038 | .028 | .033 | .045 | .029 | .043 | .032 | .038 |
| [0.40, 0.45) | .029 | .020 | .026 | .023 | .037 | .036 | .031 | .018 | .034 |
| [0.45, 0.50) | .025 | .026 | .028 | .023 | .019 | .029 | .020 | .019 | .026 |
| [0.50, 0.55) | .024 | .025 | .034 | .019 | .012 | .031 | .024 | .023 | .031 |
| [0.55, 0.60) | .020 | .012 | .016 | .015 | .023 | .020 | .019 | .022 | .014 |
| [0.60, 0.65) | .010 | .016 | .011 | .014 | .013 | .019 | .011 | .011 | .015 |
| [0.65, 0.70) | .012 | .013 | .011 | .008 | .015 | .012 | .010 | .013 | .013 |
| [0.70, 0.75) | .006 | .012 | .011 | .008 | .012 | .011 | .011 | .014 | .006 |
| [0.75, 0.80) | .010 | .011 | .005 | .012 | .009 | .006 | .009 | .006 | .011 |
| [0.80, 0.85) | .006 | .005 | .006 | .005 | .006 | .005 | .002 | .008 | .006 |
| [0.85, 0.90) | .005 | .003 | .006 | .003 | .002 | .005 | .001 | .007 | .005 |
| [0.90, 0.95) | .005 | .007 | .003 | .002 | .003 | .004 | .006 | .004 | .002 |
| [0.95, 1.00) | .002 | .004 | .003 | .004 | .001 | .001 | .003 | .001 | .001 |
| [1.00, ∞) | .008 | .005 | .010 | .007 | .004 | .004 | .008 | .005 | .005 |

### How to Seed a Pseudorandom Generator?

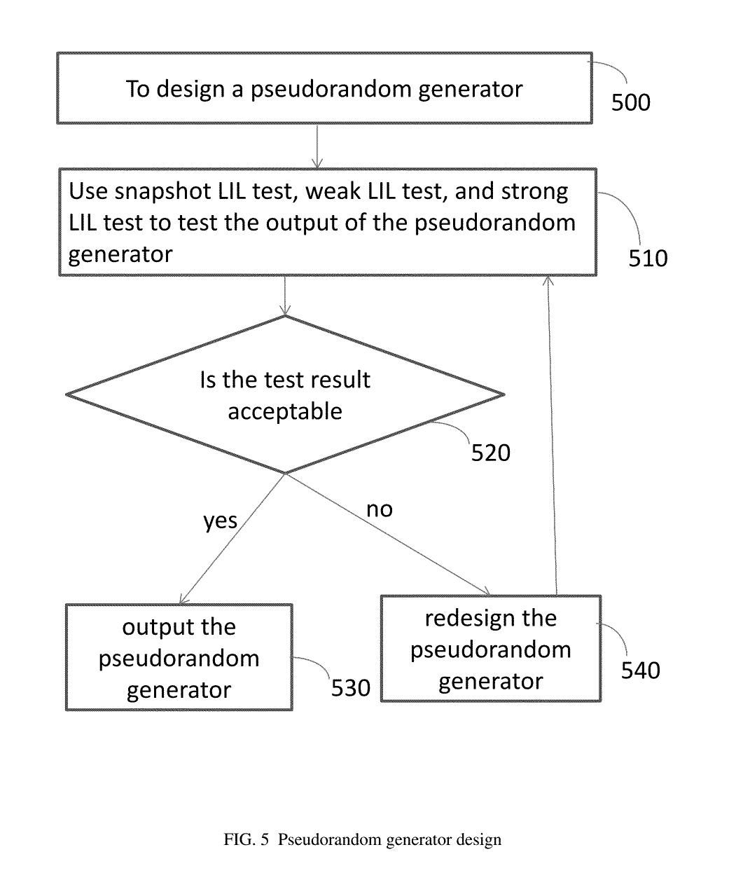

FIG. 5 describes a process of using the snapshot LIL test, weak LIL test, and strong LIL test to improve the design of pseudorandom generators. Referring therefore

TABLE 3
The distribution μₙ^{nistDRBGsha256, 1000} induced by Sₗᵢₗ for n = 2²⁶, . . . , 2³⁴

| | 2²⁶ | 2²⁷ | 2²⁸ | 2²⁹ | 2³⁰ | 2³¹ | 2³² | 2³³ | 2³⁴ |
|---|---|---|---|---|---|---|---|---|---|
| (−∞, −1) | .007 | .005 | .005 | .002 | .004 | .003 | .003 | .009 | .006 |
| [−0.1, −0.95) | .006 | .004 | .003 | .002 | .004 | .003 | .006 | .003 | .003 |
| [−0.95, −0.90) | .003 | .004 | .006 | .001 | .005 | .003 | .002 | .001 | .001 |
| [−0.90, −0.85) | .004 | .006 | .003 | .005 | .004 | .005 | .002 | .005 | .003 |
| [−0.85, −0.80) | .007 | .006 | .002 | .013 | .005 | .007 | .011 | .005 | .004 |
| [−0.80, −0.75) | .008 | .010 | .007 | .006 | .004 | .008 | .013 | .007 | .004 |
| [−0.75, −0.70) | .007 | .010 | .010 | .013 | .005 | .004 | .009 | .010 | .006 |
| [−0.70, −0.65) | .021 | .013 | .012 | .015 | .006 | .018 | .011 | .010 | .008 |
| [−0.65, −0.60) | .009 | .008 | .012 | .015 | .021 | .009 | .014 | .019 | .022 |
| [−0.60, −0.55) | .016 | .019 | .019 | .018 | .016 | .008 | .020 | .012 | .015 |
| [−0.55, −0.50) | .025 | .013 | .021 | .016 | .017 | .023 | .021 | .013 | .020 |
| [−0.50, −0.45) | .014 | .033 | .026 | .023 | .018 | .015 | .025 | .034 | .025 |
| [−0.45, −0.40) | .028 | .024 | .033 | .023 | .034 | .034 | .030 | .026 | .022 |
| [−0.40, −0.35) | .021 | .025 | .031 | .034 | .029 | .036 | .032 | .033 | .022 |
| [−0.35, −0.30) | .034 | .031 | .039 | .043 | .037 | .040 | .024 | .031 | .037 |
| [−0.30, −0.25) | .042 | .041 | .036 | .027 | .033 | .031 | .036 | .041 | .036 |
| [−0.25, −0.20) | .043 | .046 | .035 | .030 | .045 | .039 | .039 | .037 | .042 |
| [−0.20, −0.15) | .040 | .042 | .051 | .047 | .042 | .044 | .036 | .042 | .046 |
| [−0.15, −0.10) | .039 | .042 | .038 | .050 | .055 | .044 | .053 | .043 | .046 |
| [−0.10, −0.05) | .048 | .046 | .042 | .055 | .045 | .050 | .045 | .042 | .049 |
| [−0.05, 0) | .049 | .045 | .044 | .043 | .045 | .049 | .040 | .063 | .055 |
| [0, 0.05) | .055 | .059 | .050 | .062 | .049 | .054 | .056 | .040 | .043 |
| [0.05, 0.10) | .043 | .041 | .049 | .044 | .049 | .045 | .059 | .060 | .047 |
| [0.10, 0.15) | .046 | .045 | .036 | .038 | .045 | .045 | .042 | .052 | .052 |
| [0.15, 0.20) | .049 | .046 | .052 | .040 | .045 | .049 | .048 | .047 | .050 |
| [0.20, 0.25) | .054 | .043 | .033 | .046 | .046 | .047 | .033 | .037 | .043 |
| [0.25, 0.30) | .044 | .050 | .046 | .041 | .052 | .039 | .038 | .040 | .047 |
| [0.30, 0.35) | .037 | .030 | .032 | .033 | .035 | .037 | .034 | .036 | .054 |
| [0.35, 0.40) | .033 | .028 | .030 | .040 | .039 | .033 | .036 | .049 | .032 |
| [0.40, 0.45) | .025 | .030 | .036 | .027 | .024 | .026 | .029 | .025 | .033 |
| [0.45, 0.50) | .022 | .031 | .025 | .043 | .025 | .032 | .027 | .028 | .022 |
| [0.50, 0.55) | .023 | .026 | .021 | .016 | .027 | .023 | .018 | .019 | .020 |
| [0.55, 0.60) | .017 | .017 | .020 | .012 | .019 | .017 | .028 | .020 | .019 |
| [0.60, 0.65) | .024 | .016 | .018 | .014 | .025 | .022 | .018 | .011 | .015 |
| [0.65, 0.70) | .008 | .016 | .017 | .009 | .013 | .017 | .014 | .007 | .012 |
| [0.70, 0.75) | .013 | .007 | .016 | .014 | .006 | .007 | .014 | .008 | .016 |
| [0.75, 0.80) | .002 | .009 | .011 | .010 | .009 | .011 | .004 | .008 | .004 |
| [0.80, 0.85) | .011 | .011 | .012 | .007 | .001 | .004 | .005 | .007 | .007 |
| [0.85, 0.90) | .010 | .006 | .007 | .003 | .004 | .004 | .004 | .004 | .003 |
| [0.90, 0.95) | .004 | .006 | .002 | .005 | .004 | .005 | .005 | .002 | .006 |
| [0.95, 1.00) | .002 | .003 | .002 | .007 | .001 | .002 | .005 | .003 | .000 |
| [1.00, ∞) | .007 | .007 | .010 | .008 | .008 | .008 | .011 | .011 | .003 |

to FIG. 5, the design process starts at 500. For a given design of a pseudorandom generator, the process 510 uses the snapshot LIL test, weak LIL test, and strong LIL test to evaluate the given design of a pseudorandom generator, The process 520 evaluates the test outputs from 510. If the testing result is acceptable, the process 530 accepts the pseudorandom

TABLE 4
The distribution μₙ^{nistDRBGsha256, 10000} induced by Sₗᵢₗ for n = 2²⁶, . . . , 2³⁴

| | 2²⁶ | 2²⁷ | 2²⁸ | 2²⁹ | 2³⁰ | 2³¹ | 2³² | 2³³ | 2³⁴ |
|---|---|---|---|---|---|---|---|---|---|
| (−∞, −1) | .0071 | .0070 | .0062 | .0067 | .0061 | .0066 | .0069 | .0053 | .0055 |
| [−0.1, −0.95) | .0036 | .0036 | .0030 | .0032 | .0030 | .0027 | .0026 | .0031 | .0023 |
| [−0.95, −0.90) | .0047 | .0036 | .0050 | .0031 | .0032 | .0035 | .0028 | .0036 | .0029 |
| [−0.90, −0.85) | .0044 | .0057 | .0060 | .0035 | .0039 | .0047 | .0038 | .0043 | .0035 |
| [−0.85, −0.80) | .0063 | .0068 | .0058 | .0085 | .0057 | .0062 | .0066 | .0062 | .0050 |
| [−0.80, −0.75) | .0089 | .0078 | .0090 | .0082 | .0071 | .0057 | .0083 | .0071 | .0070 |
| [−0.75, −0.70) | .0112 | .0102 | .0103 | .0094 | .0096 | .0097 | .0108 | .0081 | .0099 |
| [−0.70, −0.65) | .0126 | .0128 | .0118 | .0118 | .0118 | .0113 | .0104 | .0123 | .0120 |
| [−0.65, −0.60) | .0149 | .0147 | .0166 | .0166 | .0151 | .0147 | .0185 | .0144 | .0147 |
| [−0.60, −0.55) | .0180 | .0217 | .0179 | .0181 | .0191 | .0180 | .0165 | .0169 | .0199 |
| [−0.55, −0.50) | .0216 | .0197 | .0215 | .0217 | .0201 | .0247 | .0243 | .0186 | .0188 |
| [−0.50, −0.45) | .0228 | .0275 | .0245 | .0228 | .0226 | .0220 | .0250 | .0246 | .0255 |
| [−0.45, −0.40) | .0274 | .0303 | .0310 | .0309 | .0292 | .0283 | .0319 | .0302 | .0287 |
| [−0.40, −0.35) | .0302 | .0298 | .0322 | .0331 | .0315 | .0326 | .0323 | .0354 | .0336 |
| [−0.35, −0.30) | .0353 | .0346 | .0344 | .0341 | .0361 | .0385 | .0331 | .0361 | .0329 |
| [−0.30, −0.25) | .0394 | .0385 | .0365 | .0379 | .0391 | .0408 | .0381 | .0375 | .0387 |
| [−0.25, −0.20) | .0435 | .0405 | .0391 | .0425 | .0462 | .0375 | .0454 | .0442 | .0446 |
| [−0.20, −0.15) | .0419 | .0436 | .0430 | .0430 | .0450 | .0488 | .0431 | .0429 | .0453 |
| [−0.15, −0.10) | .0439 | .0475 | .0446 | .0475 | .0506 | .0450 | .0464 | .0466 | .0491 |
| [−0.10, −0.05) | .0474 | .0426 | .0516 | .0484 | .0480 | .0499 | .0474 | .0511 | .0501 |
| [−0.05, 0) | .0488 | .0489 | .0473 | .0447 | .0474 | .0471 | .0465 | .0501 | .0481 |
| [0, 0.05) | .0497 | .0478 | .0499 | .0460 | .0499 | .0505 | .0495 | .0507 | .0485 |
| [0.05, 0.10) | .0466 | .0460 | .0470 | .0493 | .0512 | .0465 | .0474 | .0476 | .0469 |
| [0.10, 0.15) | .0436 | .0478 | .0479 | .0455 | .0475 | .0481 | .0466 | .0468 | .0494 |
| [0.15, 0.20) | .0450 | .0455 | .0467 | .0438 | .0436 | .0459 | .0487 | .0472 | .0469 |
| [0.20, 0.25) | .0435 | .0411 | .0389 | .0440 | .0418 | .0466 | .0407 | .0460 | .0431 |
| [0.25, 0.30) | .0393 | .0395 | .0392 | .0406 | .0414 | .0390 | .0407 | .0381 | .0405 |
| [0.30, 0.35) | .0370 | .0351 | .0325 | .0377 | .0334 | .0341 | .0357 | .0348 | .0352 |
| [0.35, 0.40) | .0319 | .0304 | .0323 | .0321 | .0289 | .0300 | .0290 | .0363 | .0347 |
| [0.40, 0.45) | .0308 | .0286 | .0295 | .0309 | .0264 | .0274 | .0271 | .0300 | .0293 |
| [0.45, 0.50) | .0239 | .0235 | .0249 | .0252 | .0251 | .0243 | .0243 | .0241 | .0257 |
| [0.50, 0.55) | .0203 | .0229 | .0184 | .0219 | .0213 | .0226 | .0219 | .0201 | .0202 |
| [0.55, 0.60) | .0166 | .0177 | .0166 | .0154 | .0192 | .0168 | .0189 | .0158 | .0178 |
| [0.60, 0.65) | .0162 | .0150 | .0160 | .0163 | .0167 | .0154 | .0138 | .0127 | .0144 |
| [0.65, 0.70) | .0137 | .0143 | .0145 | .0119 | .0120 | .0122 | .0123 | .0123 | .0111 |
| [0.70, 0.75) | .0102 | .0103 | .0111 | .0092 | .0109 | .0103 | .0104 | .0088 | .0091 |
| [0.75, 0.80) | .0074 | .0087 | .0089 | .0074 | .0082 | .0079 | .0084 | .0080 | .0070 |
| [0.80, 0.85) | .0081 | .0070 | .0075 | .0068 | .0060 | .0063 | .0069 | .0050 | .0067 |
| [0.85, 0.90) | .0059 | .0057 | .0047 | .0058 | .0033 | .0050 | .0037 | .0050 | .0040 |
| [0.90, 0.95) | .0044 | .0050 | .0035 | .0035 | .0039 | .0035 | .0040 | .0037 | .0044 |
| [0.95, 1.00) | .0032 | .0037 | .0033 | .0024 | .0021 | .0027 | .0026 | .0023 | .0015 |
| [1.00, ∞) | .0088 | .0070 | .0094 | .0086 | .0068 | .0066 | .0067 | .0061 | .0055 |

generator design as final. Otherwise, the process 540 redesigns the pseudorandom generator. The revised pseudorandom generator will be tested by the process 510 again.

The experimental results show that the fluctuation scale of Sₗᵢₗ for SHA1/SHA256 and Keccak256 generated sequences is very small. In order to improve the Sₗᵢₗ fluctuation

TABLE 5
The distribution μₙ^{JavaSHA1} induced by Sₗᵢₗ for
n = 2²⁶, . . . , 2³⁴ (sample size 1000)

| | 2²⁶ | 2²⁷ | 2²⁸ | 2²⁹ | 2³⁰ | 2³¹ | 2³² | 2³³ | 2³⁴ |
|---|---|---|---|---|---|---|---|---|---|
| (−∞, −1) | .011 | .008 | .012 | .007 | .006 | .006 | .008 | .006 | .004 |
| [−0.1, −0.95) | .002 | .005 | .002 | .002 | .004 | .001 | .001 | .002 | .002 |
| [−0.95, −0.90) | .005 | .007 | .004 | .008 | .004 | .004 | .003 | .003 | .003 |
| [−0.90, −0.85) | .008 | .005 | .006 | .003 | .008 | .005 | .001 | .003 | .007 |
| [−0.85, −0.80) | .007 | .011 | .006 | .005 | .007 | .006 | .003 | .004 | .006 |
| [−0.80, −0.75) | .010 | .006 | .010 | .011 | .010 | .005 | .003 | .008 | .006 |
| [−0.75, −0.70) | .015 | .010 | .013 | .010 | .002 | .004 | .013 | .011 | .012 |
| [−0.70, −0.65) | .013 | .017 | .010 | .007 | .010 | .006 | .011 | .009 | .009 |
| [−0.65, −0.60) | .019 | .017 | .013 | .013 | .011 | .017 | .011 | .013 | .007 |
| [−0.60, −0.55) | .014 | .021 | .015 | .022 | .019 | .018 | .017 | .022 | .017 |
| [−0.55, −0.50) | .020 | .032 | .024 | .019 | .022 | .022 | .021 | .021 | .020 |
| [−0.50, −0.45) | .030 | .030 | .027 | .028 | .024 | .022 | .027 | .025 | .022 |
| [−0.45, −0.40) | .034 | .035 | .037 | .021 | .025 | .020 | .031 | .033 | .037 |
| [−0.40, −0.35) | .036 | .035 | .037 | .038 | .033 | .037 | .032 | .039 | .032 |
| [−0.35, −0.30) | .042 | .037 | .044 | .031 | .034 | .035 | .035 | .033 | .042 |
| [−0.30, −0.25) | .043 | .033 | .042 | .039 | .032 | .043 | .046 | .040 | .041 |
| [−0.25, −0.20) | .042 | .039 | .040 | .053 | .048 | .039 | .047 | .039 | .048 |
| [−0.20, −0.15) | .053 | .047 | .042 | .049 | .052 | .042 | .039 | .038 | .029 |
| [−0.15, −0.10) | .055 | .045 | .049 | .056 | .053 | .038 | .048 | .052 | .043 |
| [−0.10, −.05) | .047 | .046 | .051 | .049 | .046 | .054 | .041 | .049 | .053 |
| [−.05, 0) | .040 | .037 | .048 | .047 | .045 | .055 | .053 | .059 | .048 |
| [0, .05) | .042 | .046 | .050 | .053 | .041 | .041 | .041 | .045 | .044 |
| [.05, 0.10) | .039 | .053 | .048 | .048 | .043 | .050 | .049 | .038 | .049 |
| [0.10, 0.15) | .040 | .054 | .039 | .049 | .058 | .064 | .039 | .050 | .054 |
| [0.15, 0.20) | .042 | .047 | .039 | .047 | .051 | .058 | .064 | .041 | .038 |
| [0.20, 0.25) | .034 | .030 | .029 | .031 | .040 | .053 | .050 | .049 | .040 |
| [0.25, 0.30) | .027 | .036 | .040 | .032 | .041 | .033 | .039 | .040 | .044 |
| [0.30, 0.35) | .034 | .027 | .034 | .033 | .043 | .022 | .033 | .040 | .040 |
| [0.35, 0.40) | .026 | .033 | .030 | .043 | .030 | .030 | .030 | .022 | .038 |
| [0.40, 0.45) | .030 | .030 | .016 | .024 | .030 | .026 | .034 | .022 | .031 |
| [0.45, 0.50) | .020 | .021 | .023 | .028 | .019 | .033 | .028 | .022 | .021 |
| [0.50, 0.55) | .020 | .018 | .018 | .008 | .025 | .024 | .013 | .026 | .018 |
| [0.55, 0.60) | .019 | .012 | .020 | .020 | .017 | .020 | .022 | .015 | .023 |
| [0.60, 0.65) | .015 | .015 | .014 | .009 | .015 | .015 | .015 | .017 | .019 |
| [0.65, 0.70) | .011 | .013 | .014 | .008 | .010 | .008 | .009 | .015 | .013 |
| [0.70, 0.75) | .009 | .005 | .011 | .013 | .008 | .009 | .009 | .015 | .012 |
| [0.75, 0.80) | .011 | .009 | .007 | .004 | .006 | .009 | .009 | .006 | .003 |
| [0.80, 0.85) | .007 | .008 | .009 | .004 | .008 | .009 | .002 | .009 | .007 |
| [0.85, 0.90) | .008 | .004 | .007 | .008 | .004 | .003 | .006 | .008 | .007 |
| [0.90, 0.95) | .006 | .004 | .007 | .002 | .004 | .004 | .002 | .004 | .003 |
| [0.95, 1.00) | .003 | .004 | .002 | .010 | .002 | .004 | .004 | .002 | .002 |
| [1.00, ∞) | .011 | .008 | .011 | .008 | .010 | .006 | .011 | .005 | .006 |

scale within the interval [−1, 1] for sequences generated by pseudorandom generators, we need a better seeding approach.

In existing hash function design, the input to the hash function is padded with a bit 1 followed by 0s (and the length of the message itself in case of SHA1 and SHA2) so that

TABLE 6
The probability distances Δ_{wlil} and RMSD_{wlil}

| | | | DRBG- | DRBG- |
|---|---|---|---|---|
| | Java | DRBG- | SHA256 | SHA256 |
| | SHA1PRNG | SHA1 | (1000) | (10000) |
| Δ_{wlil, 0.1} | 0.140 | 0.194 | 0.200 | 0.045 |
| Δ_{wlil, 0.05} | 0.276 | 0.224 | 0.289 | 0.063 |
| RMSD_{wlil, 0.1} | 0.004647 | 0.003741 | 0.004984 | 0.00118 |
| RMSD_{wlil, 0.05} | 0.004042 | 0.003023 | 0.004423 | 0.001107 |

TABLE 7
total variation and Hellinger distances

| n | 2²⁶ | 2²⁷ | 2²⁸ | 2²⁹ | 2³⁰ | 2³¹ | 2³² | 2³³ | 2³⁴ |
|---|---|---|---|---|---|---|---|---|---|
| d₁ | .074 | .704 | .064 | .085 | .067 | .085 | .074 | .069 | .071 |
| H₁ | .062 | .067 | .063 | .089 | .066 | .078 | .077 | .061 | .068 |
| RMSD₁ | .005 | .005 | .004 | .005 | .004 | .006 | .005 | .005 | .005 |
| d₂ | .066 | .072 | .079 | .067 | .084 | .073 | .065 | .078 | .083 |
| H₂ | .060 | .070 | .073 | .062 | .077 | .066 | .067 | .070 | .087 |
| RMSD₂ | .004 | .005 | .005 | .004 | .005 | .004 | .004 | .005 | .005 |
| d₃ | .076 | .069 | .072 | .093 | .071 | .067 | .078 | .081 | .066 |
| H₃ | .082 | .064 | .068 | .088 | .079 | .073 | .076 | .074 | .080 |
| RMSD₃ | .005 | .004 | .004 | .006 | .004 | .004 | .005 | .005 | .005 |
| d₄ | .021 | .022 | .026 | .024 | .022 | .024 | .026 | .024 | .021 |
| H₄ | .019 | .021 | .024 | .024 | .022 | .023 | .025 | .022 | .021 |
| RMSD₄ | .001 | .001 | .002 | .001 | .001 | .002 | .002 | .002 | .001 |

the length of the result is a multiple of the hash function message block size. The message blocks are then processed one by one and the hash values are updated correspondingly. If the seedscounters information to the generators are small (e.g., smaller than 440 bits for SHA1 and SHA256) such as in NIST DRBG, then the input to each hash function call will only have one message block and there is no chance for the initial hash values (or internal state of the sponge function in SHA3) to be dynamically changed. Furthermore, if the counter mode is used and the counter is not significantly changed, then inputs to consecutive primitive function calls are almost identical (only a few bits difference).

In NIST DRBG in Barker and Kelsey (2012), one counter V can be used for at most 2¹⁹ bits output. If the seedscounters information to the generators are larger than 448 bits but smaller than 512 bits for SHA1/SHA256 based generators, then the padded inputs will have the form M₁M₂ where M₂ consists mainly of the padded 0-bits. Thus for each hash function call, the hash function will process the same last message block M₂ with different 1st hash values (or internal hash function state).

We suspect that these “sparse” inputs to the generators may reduce the randomness property (or reveal the non-randomness property) of the underlying primitives. Thus it is reasonable to design a better seeding process for pseudorandom generators.

In NIST DRBG in Barker and Kelsey (2012), the seeding information is used to derive a start counter V of seedlen-bits which is 440 for SHA1/SHA2. The length of V is chosen in such a way that each hash function call will only have one message block to process. The value of V is revised after at most 2¹⁹-bits output using G(V+G(0x03∥V)+C+reseed_counter) where C contains the entropy of the original seeding. As we have observed in the experiments, the generated sequences show strong non-randomness properties with stable Sₗᵢₗ values.

We recommend revising the seeding process in such a way that each hash function call has significantly different last message block and different internal hash algorithm state when the last message block is processed. This could be achieved by a second independent pseudorandom generator. In other words, from the seeding information, we could generate an initial pseudorandom sequence using another pseudorandom generator.

The other pseudorandom generator for preprocessing the seeding information does not need to be a very secure one. For example, we may use linear feedback shift registers or other weak pseudorandom generators. The output of this initial preprocessing could be used by the pseudorandom generator to generate strong pseudorandom sequences. Specifically, we recommend the following seeding approach with two choices for the value of vLen which is defined using seedln from NIST DRBG in Barker and Kelsey (2012).

Approach: The seeding information is converted to a series of values V₀, V₁, . . . , V_{T} using a second independent pseudorandom generator such that each Vᵢ is of vLen bits and T is the maximal number of requests between re-seeds as defined in NIST DRBG in Barker and Kelsey (2012). The generated pseudorandom sequence is G(V₀) . . . G(V_{T}) where G is a hash function or block cipher primitive. Note that the value of Vᵢ for 0<i≦T may or may not depend on the value of G(V₀) . . . G(Vᵢ₋₁). In other words, let G̅ be the second independent pseudorandom generator. Then we have Vᵢ= G̅(seed, G(V₀) . . . G(Vᵢ₋₁)) where seed is the seeding information. For the first choice, we set vLen=seedlen. The second choice is for hash function based generators only and we set vLen=seedlen+u where u is the hash function G's message block size.

The values of V₀, V₁, . . . , V_{T} are generated from the seeding information (and it may also use the already outputed pseudorandom bits) using a second independent pseudorandom generator such as block cipher or hash function based generators or linear feedback shift registers (LFSR). For the first choice of vLen, we achieve the same efficiency of NIST DRBG in Barker and Kelsey (2012) by having one message block for each hash function call. The advantage of the second choice for vLen is that if the G is a hash function, then the hash function internal states (or the first hash values) are dynamically changed for each hash function call and we expect this will produce better randomness properties within the generated sequences. Our experiments show that sequences generated with the above proposed approach have better fluctuation scale interval for the value Sₗᵢₗ.

In practice, one can use the linear feedback shift registers (LFSR) could be designed based on feedback polynomials such as x³²+x²²+x²+x+1.

What is claimed is:

1. A method for evaluating a random and pseudorandom source, comprising:
a) fixing a number n, a number m, and a threshold value α;
b) said random and pseudorandom source being used to generate m sequences of length n;
c) an induced statistical distribution P on said generated m sequences being calculated according to a statistical law;
d) an induced statistical distribution UP on uniformly chosen sequences being calculated according to said statistical law;
e) a statistical distance d between said distribution P and said distribution UP being calculated; and
f) said random and pseudorandom source being concluded as high quality if said calculated statistical distance d is smaller than said α.

2. The method defined in claim 1 wherein said induced statistical distributions are calculated according to a snapshot LIL test, the method further comprising:
a) the probability distribution P on said generated sequences being calculated as μₙ^{R}^{ₙ}(I)=Prob[Sₗᵢₗ(x) ∈ I, x ∈ Rₙ] wherein Rₙ is a collection of said generated sequences; and
b) the probability distribution UP on a uniform distribution being calculated as μₙ^{U}((−∞, x])=\sqrt{2 ln ln n}∫_{-∞}^{∞}φ(y\sqrt{2ln ln n})dy.

3. The method defined in claim 2 wherein said statistical distance is calculated according to Hellinger distance.

4. The method defined in claim 2 wherein said statistical distance is calculated according to total variation distance.

5. The method defined in claim 2 wherein said statistical distance is calculated according to root-mean-square distance.

6. A method for designing a pseudorandom source, comprising:
a) the method in claim 2 being used to evaluate said pseudorandom source;
b) said evaluation result being used to improve the design of said pseudorandom source; and
c) said pseudorandom source being revised until said evaluation result is acceptable.

7. The method defined in claim 1 wherein said induced statistical distributions P and UP are calculated according to a weak LIL test, the method further comprising:
a) selecting parameters for said weak LIL test;
b) calculating the probability distribution P according to probabilities that said generated sequences pass said weak LIL test;
c) calculating the probability distribution UP according to probabilities that uniformly chosen sequences pass said weak LIL test;

8. The method defined in claim 7 wherein said statistical distance is calculated according to average absolute probability distance.

9. The method defined in claim 7 wherein said statistical distance is calculated according to root-mean-square deviation.

10. The method defined in claim 1 wherein said induced statistical distributions P and UP are calculated according to a strong LIL test, the method further comprising:
a) selecting parameters for said strong LIL test;
b) calculating the probability distribution P according to probabilities that said generated sequences pass said strong LIL test;
c) calculating the probability distribution UP according to probabilities that uniformly chosen sequences pass said strong LIL test;

11. The method defined in claim 10 wherein said statistical distance is calculated according to average absolute probability distance.

12. The method defined in claim 10 wherein said statistical distance is calculated according to root-mean-square deviation.

13. A method for evaluating a random and pseudorandom source, comprising:
a) fixing a number n and a number Tn;
b) said random and pseudorandom source being used to generate Tri, sequences of length n;
c) an induced statistical distribution P on said generated m sequences being calculated according to the law of the iterated logarithms; and
d) said statistical distribution P being used the evaluate said random and pseudorandom source.
